(19) United States
(12) Patent Application Publication
(10) Pub. No.: US 2003/0115176 A1
(43) Pub. Date: Jun. 19, 2003

(54) Information system

(76) Inventors: Peter James Bobroff, Kambah (AU); David Ronald Thompson, Narrabundah (AU)

Correspondence Address: Flixco PTY Limited, 14 Coglin Place, Kambah, 2902, AU

(21) Appl. No.: 10/168,960

(22) PCT Filed: Jan. 8, 2001
(86) PCT No.: PCT/AU01/00013

(30) Foreign Application Priority Data
Jan. 7, 2000 (AU) PQ 4985

(51) Int. Cl. G06F 7/00

(52) U.S. Cl. 707/1

(57) ABSTRACT

A computer implemented information system which arranges information according to types, members and associations wherein types group members with common attributes and wherein associations define relationships between types. The invention provides all the functionality of modern databases, spreadsheets and word processors all in the one program.

### FIELD OF THE INVENTION

The present invention relates to information systems and, in particular to a computer implemented information system which arranges information according to types, members and associations wherein types group members with common attributes and wherein associations define relationships between types.

The invention has been developed primarily for use as an information system which provides all the functionality of modem databases, spreadsheets and word processors all in the one program, and will be described hereinafter with reference to this application. However, it will be appreciated that the invention is not limited to this particular field of use.

### PRIOR ART

Prior art information systems have a number of deficiencies. Firstly, existing relational databases need to be set up by experienced computer programmers with an extensive knowledge of tables, foreign keys and the like. When a user wishes to add a new type of information to the database or create a cross-reference from one table to another, the programmer needs be employed to effect this change. Adding new tables to an existing relational database is a time consuming and difficult task, and is not one that typical users are equipped to perform. Secondly, although humans think in terms of entities (types) and the relationships between those entities (associations), existing database systems do not store or retrieve information in this way. Thirdly, existing information systems often present bare information and do not present the reasoning or logic behind that information. In order to obtain more detailed or associated information, users need to either have an extensive knowledge of the schema of the database, or the programmers need to manually develop a sophisticated set of help instructions to answer the user's questions. Fourthly, existing word processors, spreadsheets and databases all use different file formats. When one program wishes to communicate with the other, they must undergo a format conversion step. Given the large number of different brands of word processor, spreadsheet and database, programs need to supply a large number of conversion tools and users need to understand the conversion problem, in order to function properly.

It is an object of the present invention to overcome or ameliorate at least some of the disadvantages of the prior art, or to provide a useful alternative.

### THE INVENTION

According to one aspect of the invention there is provided a computer implemented information system which arranges information according to types, members and associations wherein types group members with common attributes and wherein associations define relationships between types.

Preferably, particular types have members which belong to that type and which hold examples of information that have the attributes of that type.

Preferably, some types have sub-types which have more narrowly defined attributes than their parent type.

Preferably, some types have super-types which have less narrowly defined attributes that their child type.

Preferably, the interrelation of the types, associations, members, sub-type and super-types defines a concept net.

According to another aspect of the invention there is provided an information system including:

(a) a Concept Net which is referenced by;

(b) a Universal Logic which provides data organised into Phrases for;

(c) a Logical External Interface which collects, formats and presents the data to Display Means. Preferably, the Display Means can be acted upon by;

(d) a User Action System which provides an extensible set of user Operations which enable the user to enter and modify data in the Concept Net.

According to another aspect of the invention there is provided a computer implemented information system including a Concept Net which is organised so that it can hold sufficient information to:

(a) define itself;

(b) define user applications; and

(c) control the operation of the entire information system.

Preferably, the Concept Net defines itself using Types, Subtypes, Contained Types, Nested Types, Associations and/or Roles.

According to another aspect of the invention there is provided a method for organising a Concept Net so that it can hold all information necessary to:

(a) define itself—using Types, Subtypes, Contained Types, Nested Types, Associations and Roles;

(b) define user applications—using Logic, all the remaining system Definition Types, Styles, Operations; and

(c) control the operation of the entire information system including user applications.

According to another aspect of the invention there is provided a computer implemented method for implementing a user interface covering all information contained in a Concept Net, which relies only on information within the same Concept Net and in which no programming or arbitrary human decisions are required

According to another aspect of the invention there is provided a computer implemented method for intersecting on a Connection, based upon ordered storage.

According to another aspect of the invention there is provided a method for clearly specifying a situation which must not be allowed to occur in the Concept Net (ie a Constraint) which leads by Transformation to an efficient enforcement mechanism on insertion and deletion in Associations and naturally results in a clear summary of all constraints that effect a particular Association.

According to another aspect of the invention there is provided an information system which employs a method which BOTH allows a Logical Association to maintain a parallel Enumerated Implementation to save continual re-interpretation AND which allows changes in one Enumerated Association to have consequential effects in another Enumerated Association by allowing an Association to be both Enumerated and Logical.

According to another aspect of the invention there is provided a method for constructing an information system including:

(a) a Concept Net which is organised by Types, Associations, Subtyping, Nested Types and Contained Types such that it can be directly referenced by:

(b) a Universal Logic consisting of Alternatives, References and Connections sufficiently powerful to control all display, manipulation, calculation, access and decision making necessary for all business purposes and wherein the Logic provides data organised into Connection Phrases, Reference Phrases and Instance Phrases for:

(c) a Logical External Interface which (in accordance with Styles) collects, formats and presents the data to interactive windows, reports and external files; and wherein every phrase of the interactive windows can be acted upon by:

(d) a User Action System providing an extensible set of user Operations which are available on every Phrase of the appropriate Type, which are sufficient to productively enter and modify any data in the Concept Net and to extend the organisation of the Concept Net without limit.

According to another aspect of the invention there is provided a computer implemented information system which arranges information according to instances wherein instances include numbers, ephemerals and things.

Preferably, things include formal references, text, roles, definitions, users, and other user-created things.

### THE PREFERRED EMBODIMENT

A preferred embodiment of the invention will now be described, by way of example only, with reference to the accompanying drawings in which:

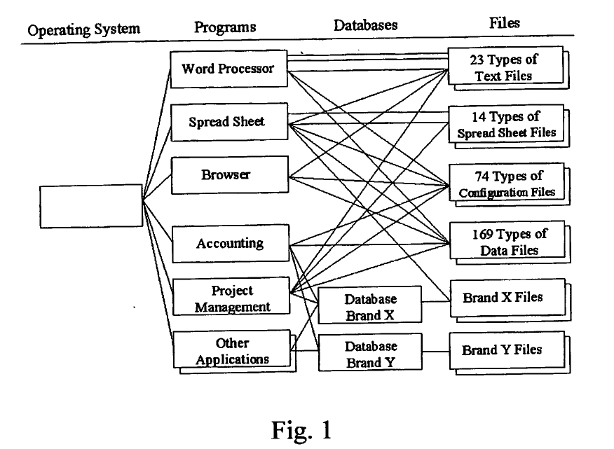

FIG. 1 is a diagram showing the relationships between the operating system, programs, databases and files in prior art File Oriented Programs (FOPs);

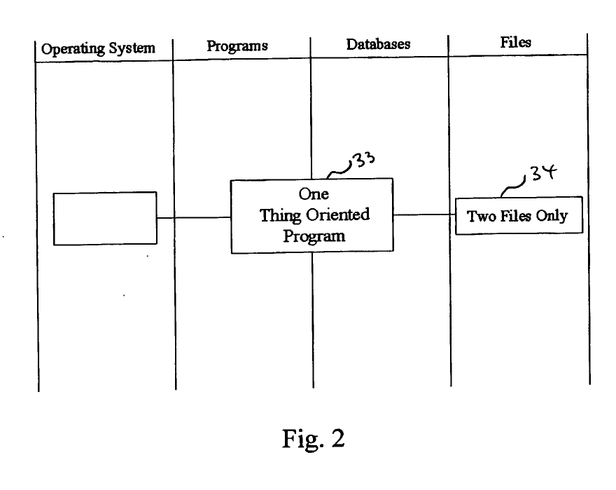

FIG. 2 is a diagram corresponding to FIG. 1 showing the relationships between the operating system, programs, databases and files in Thing Oriented Programs (TOPs), such as the present invention;

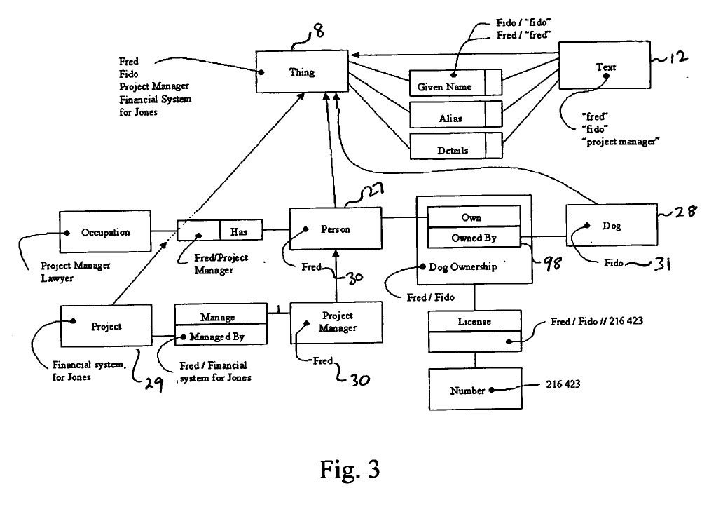

FIG. 3 is a diagram illustrating the relationships between types 20 and associations 21;

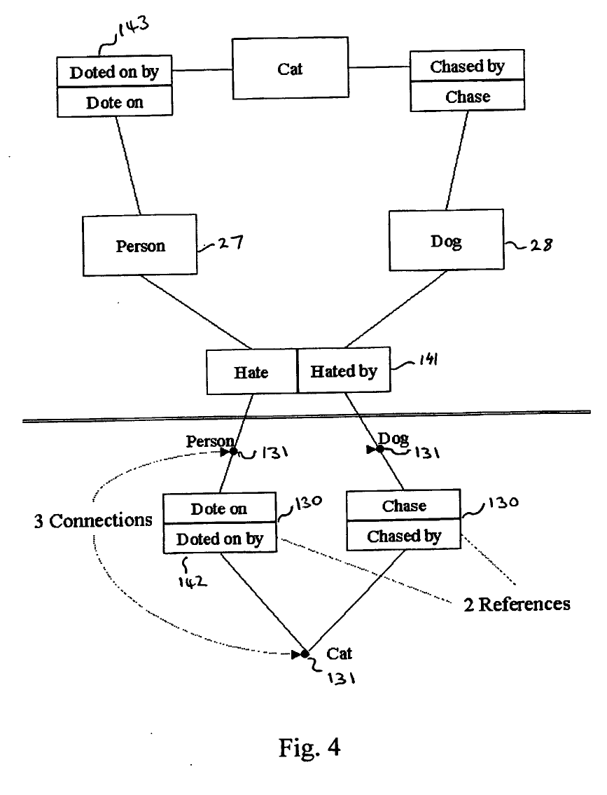

FIG. 4 is a diagram illustrating an example logical association;

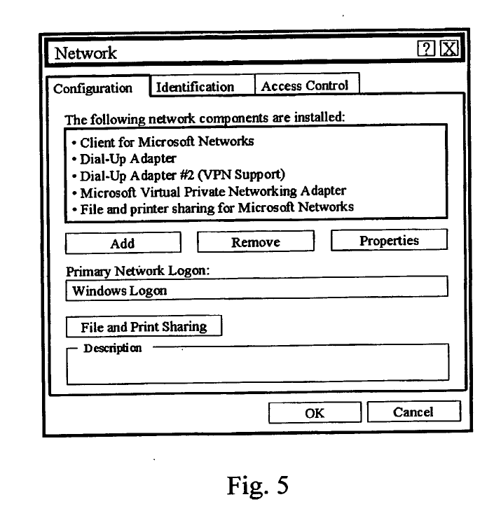

FIG. 5 shows an example of a particular file oriented program display;

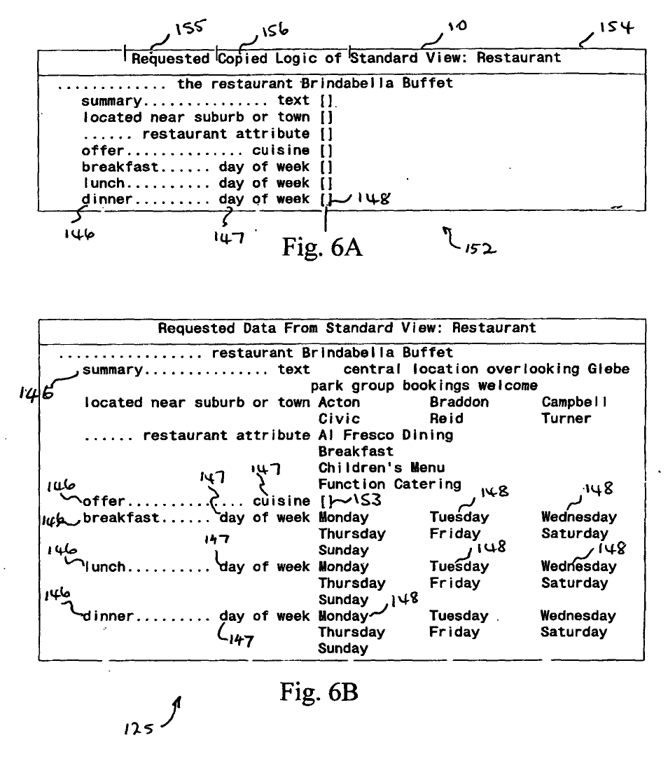

FIG. 6(a) shows a sample logic display 152;

FIG. 6(b) shows a sample data display 125 corresponding to the logic display of FIG. 6a;

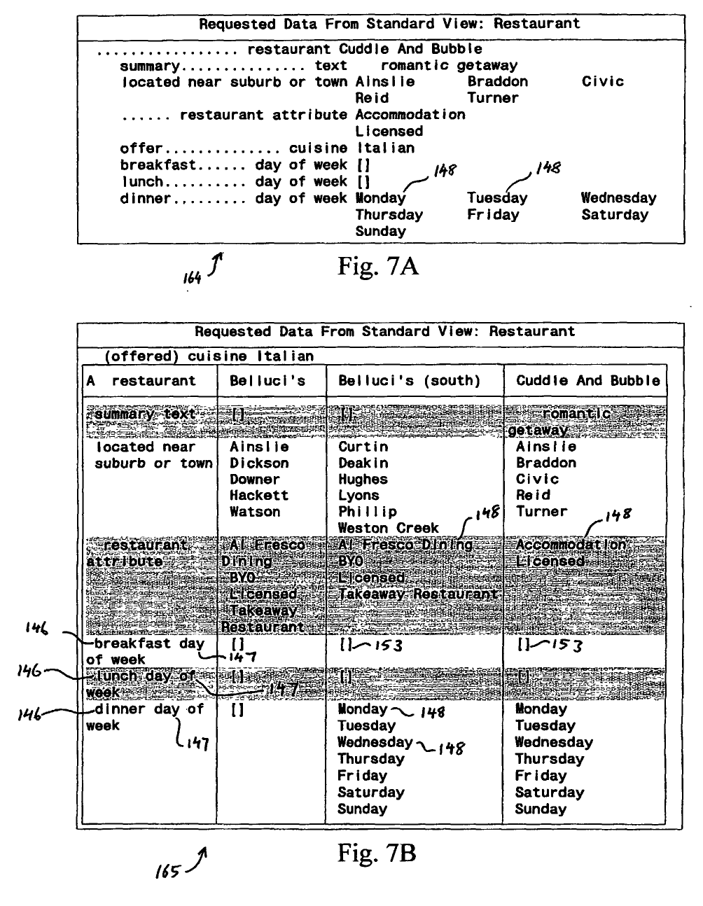

FIG. 7(a) shows some sample data represented as a textual presentation 164;

FIG. 7(b) shows the sample data of FIG. 7a, represented in a tabular presentation 165;

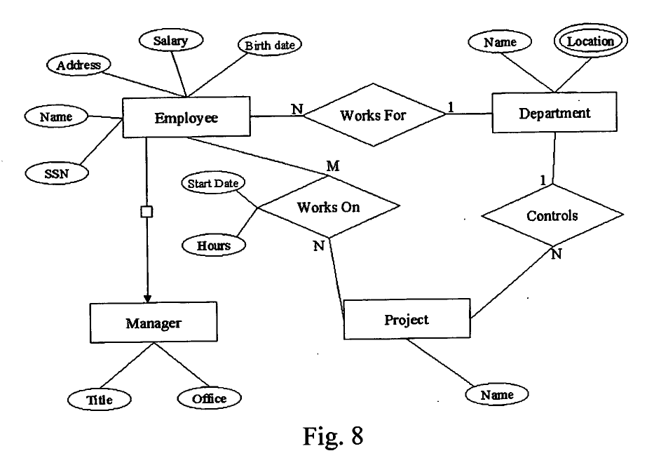

FIG. 8 shows an entity relationship diagram, as used in the creation of prior art relational databases;

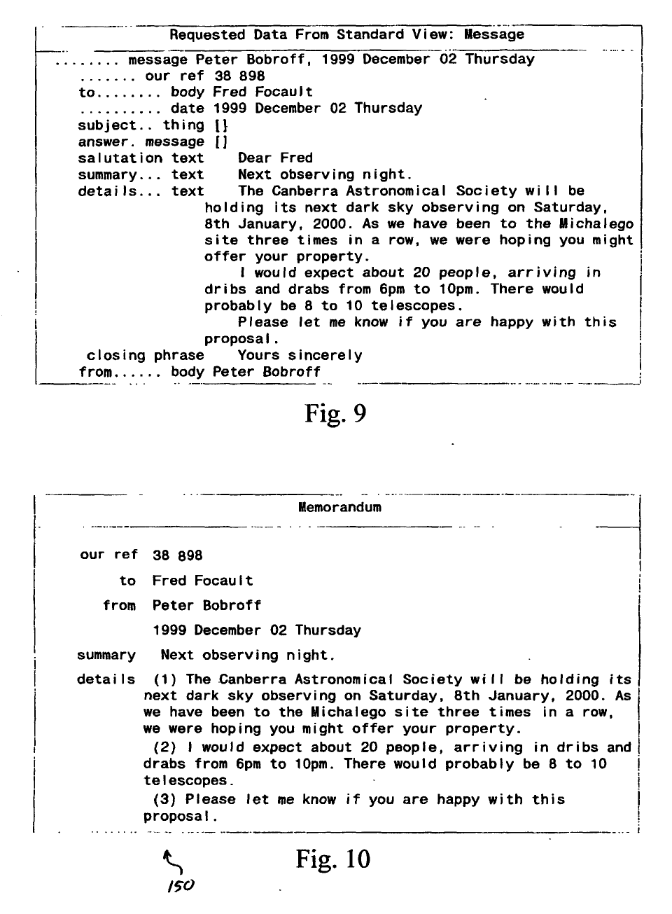

FIG. 9 is an example screen showing the present invention when used to create a message;

FIG. 10 shows the message of FIG. 9 in memorandum style 150;

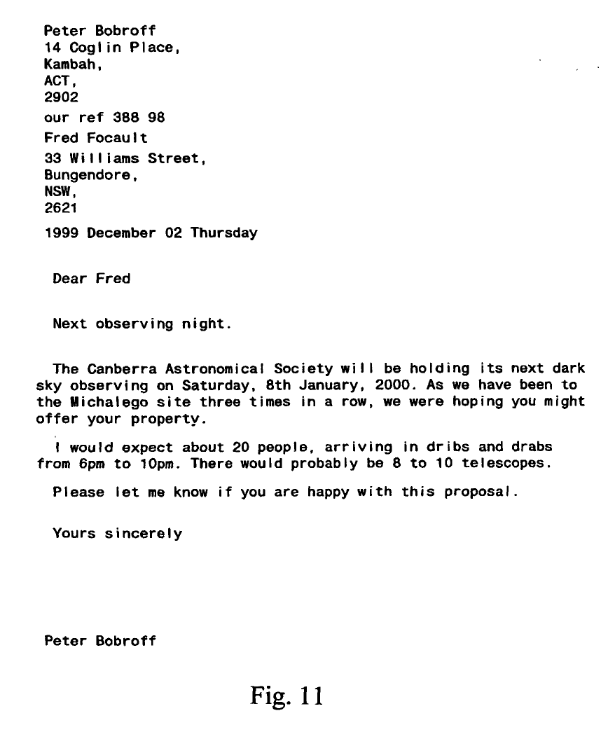

FIG. 11 shows the message of FIG. 9 in letter style;

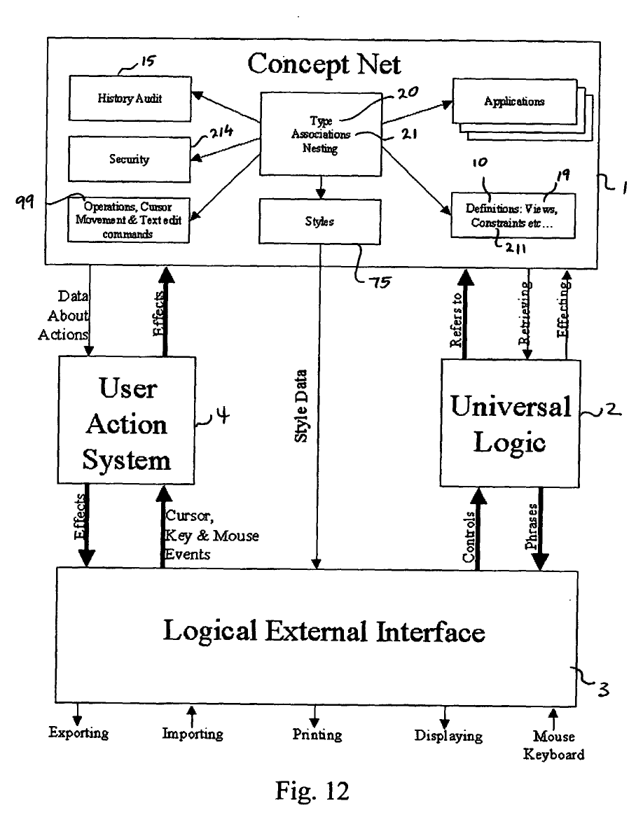

FIG. 12 is a diagram illustrating the overall structure of the preferred embodiment of the present invention;

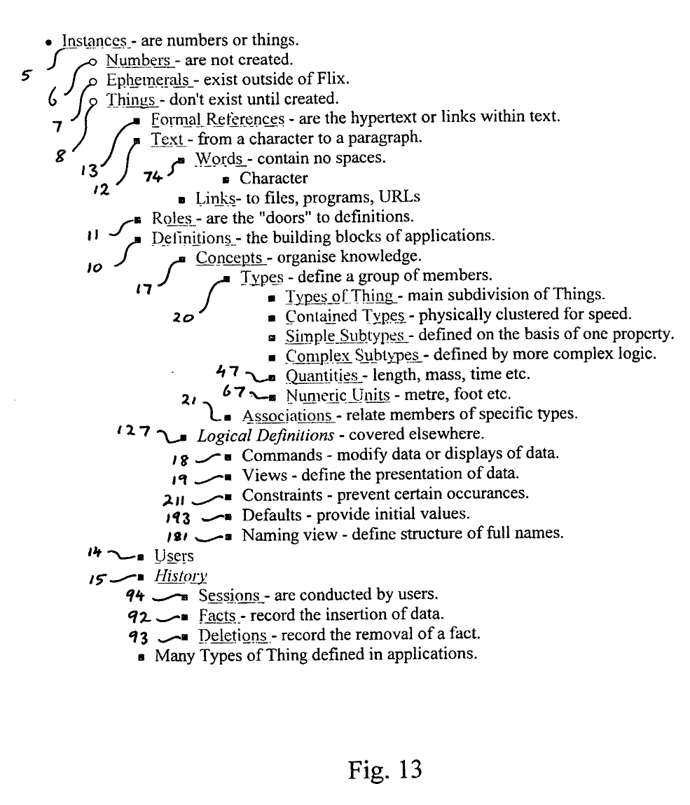

FIG. 13 is an hierarchal diagram of the major Types 20 making up the concept net 1 of the present invention;

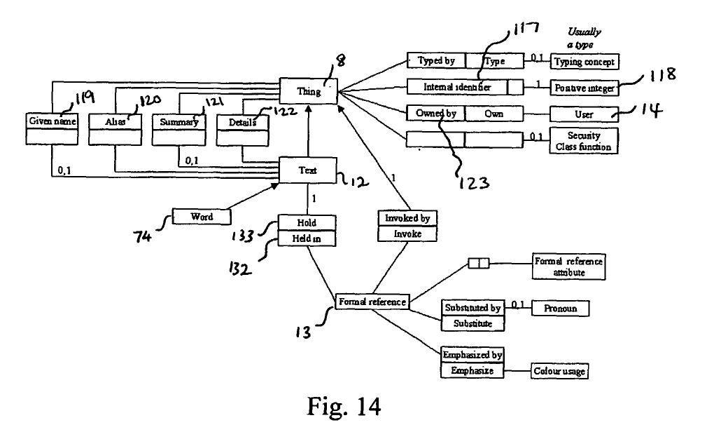

FIG. 14 is a diagram illustrating the relationship between Things 20 and Text 12 in the Concept Net 1 of the present invention;

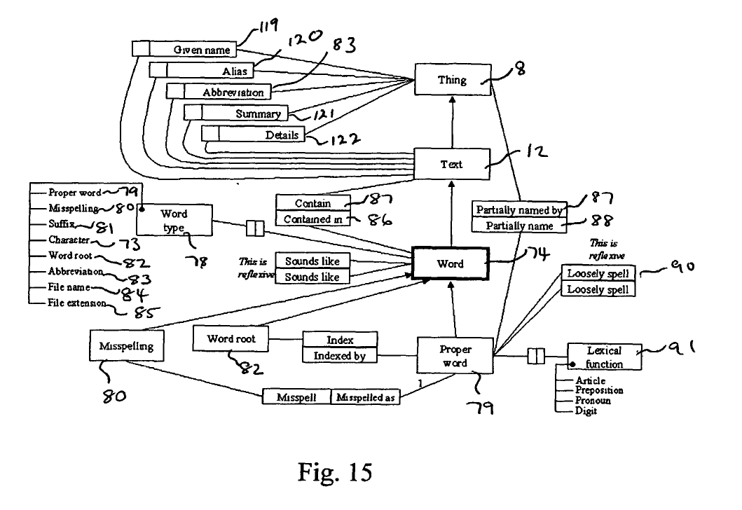

FIG. 15 is a diagram illustrating the Concept Net of Words 74;

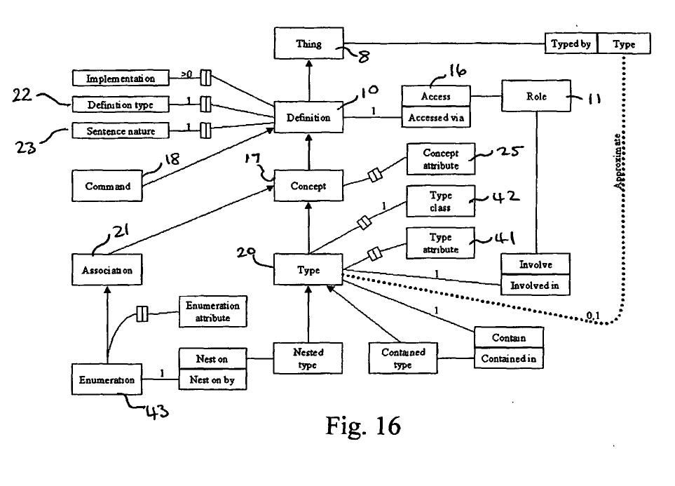

FIG. 16 is a diagram illustrating the Concept Net of Definitions 10;

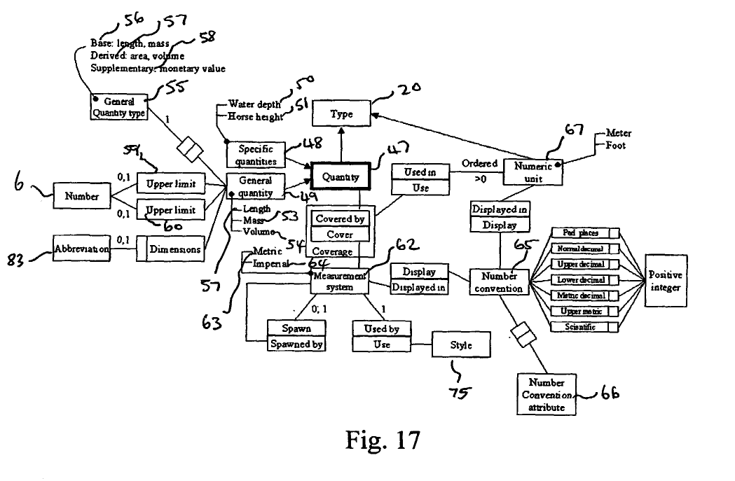

FIG. 17 is a diagram illustrating the Concept Net of Quantities 47;

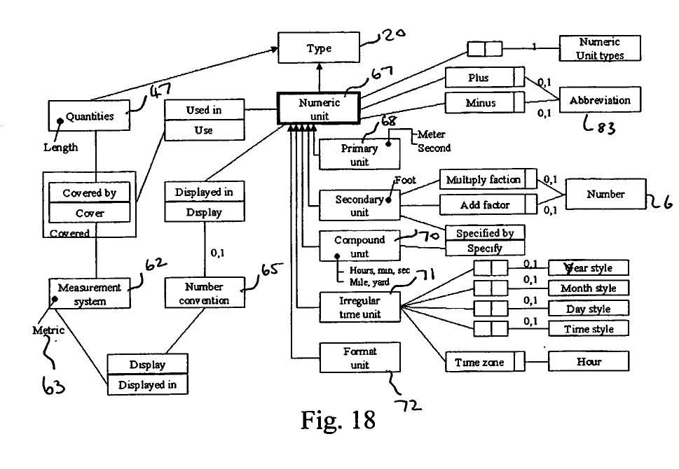

FIG. 18 is a diagram illustrating the Concept Net of Numeric Units 67;

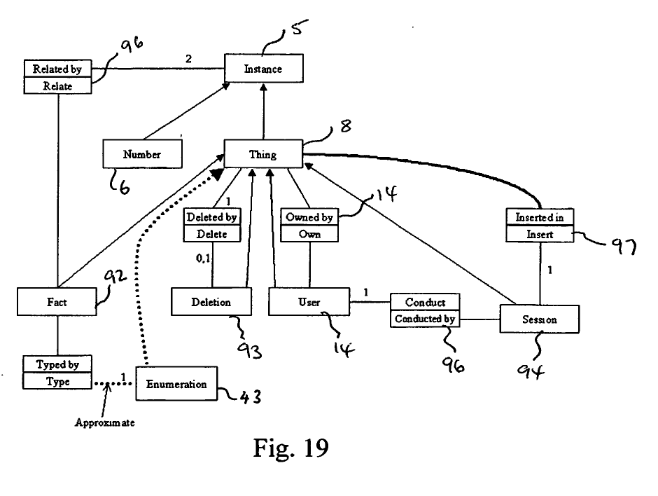

FIG. 19 is a diagram illustrating the Concept net of Facts 92, Deletions 93 and Sessions 94;

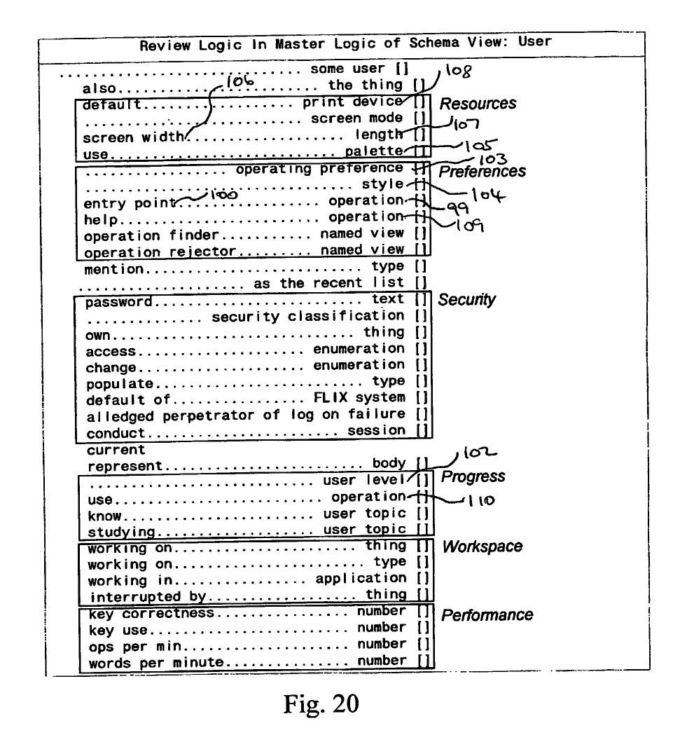

FIG. 20 is a sample display illustrating the properties of a user 14 of the present invention;

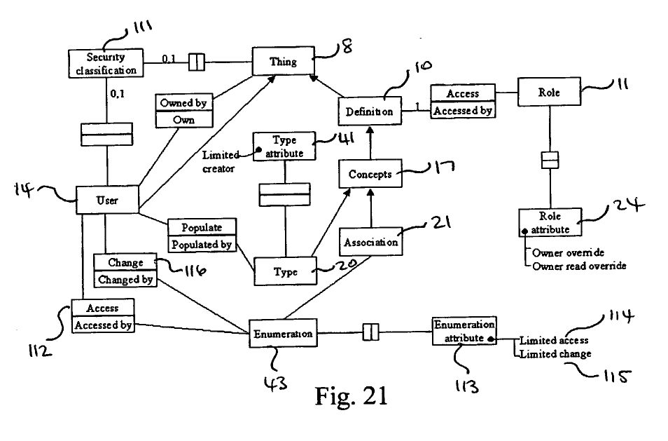

FIG. 21 is a diagram illustrating the Concept Net of the security features 214 of the preferred embodiment of the present invention;

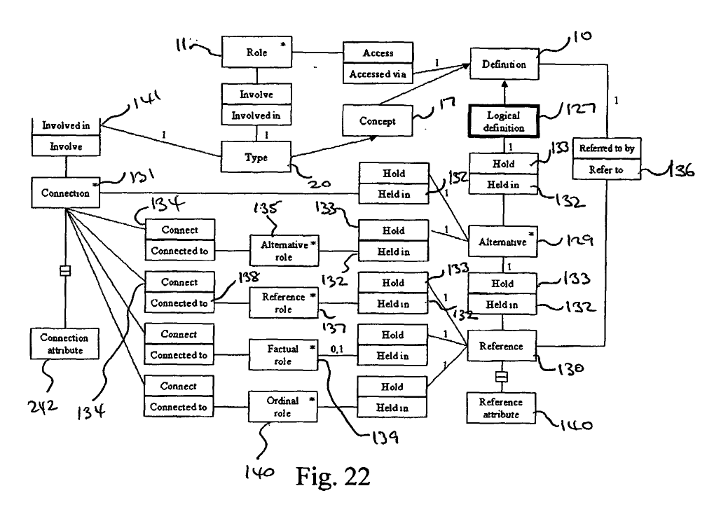

FIG. 22 is a diagram illustrating the Concept Net of Logical Definitions 127;

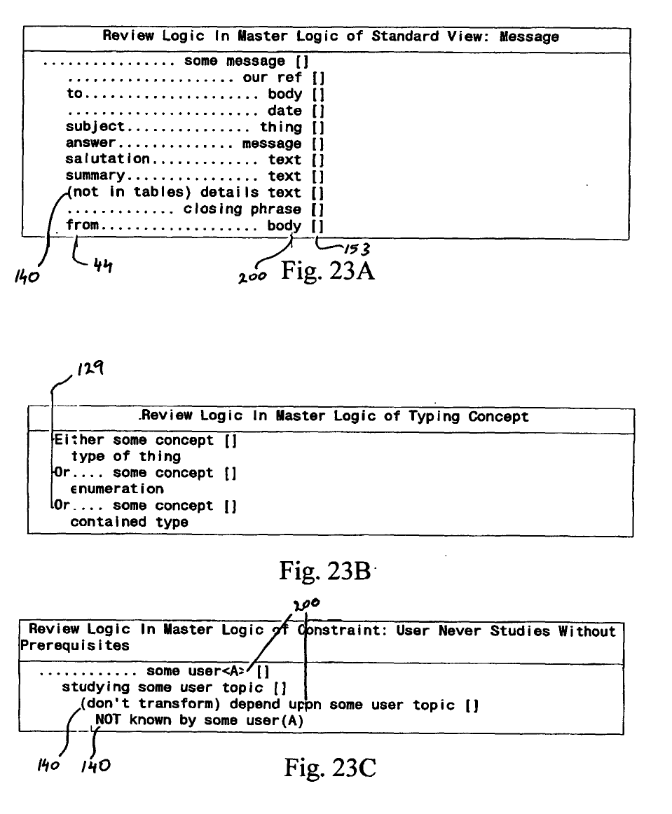

FIG. 23(a) shows an example logical display 124 of a Message;

FIG. 23(b) shows an example logical display 124 of a Concept 17;

FIG. 23(c) shows an example logical display 124 of a Constraint 211;

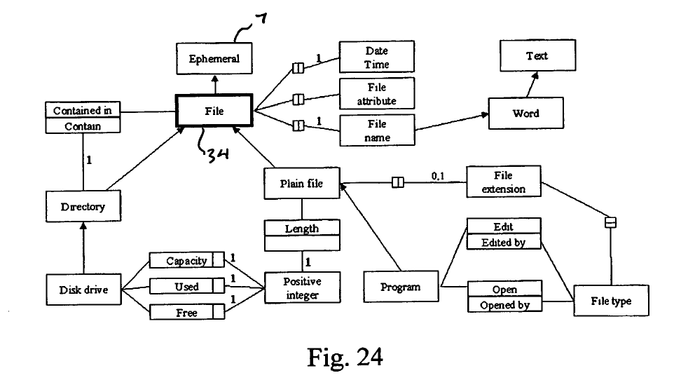

FIG. 24 is a flow diagram illustrating the Concept Net 124 of Files 34;

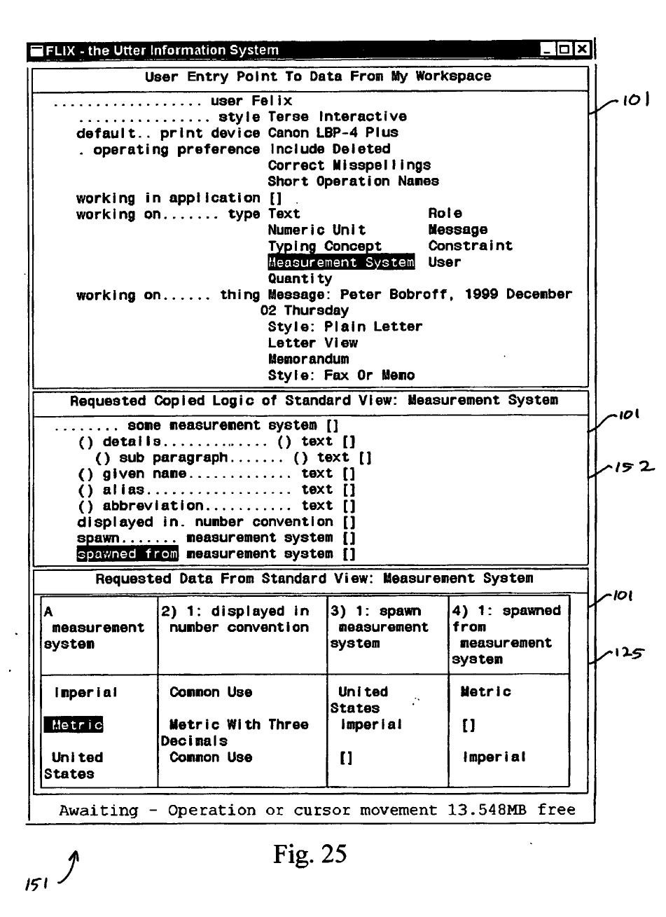

FIG. 25 shows an example stack of displays in the preferred embodiment of the present invention;

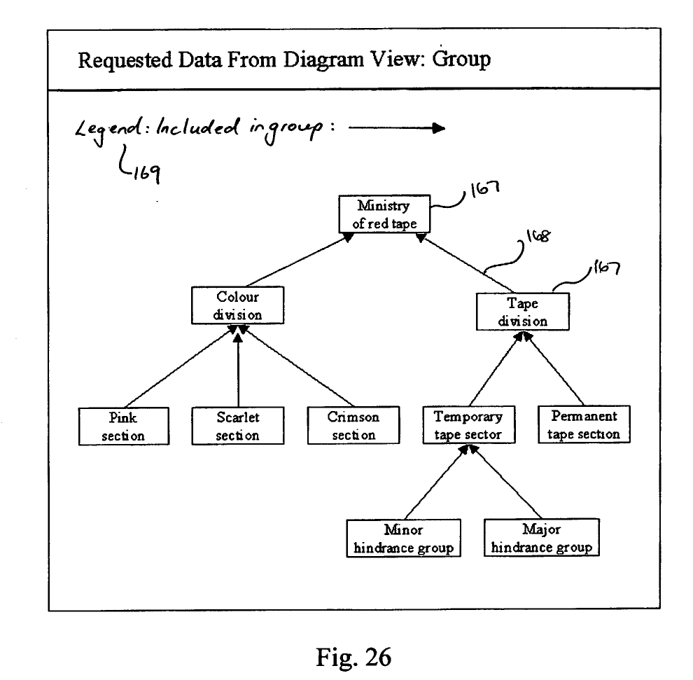

FIG. 26 shows a sample diagram presentation 166;

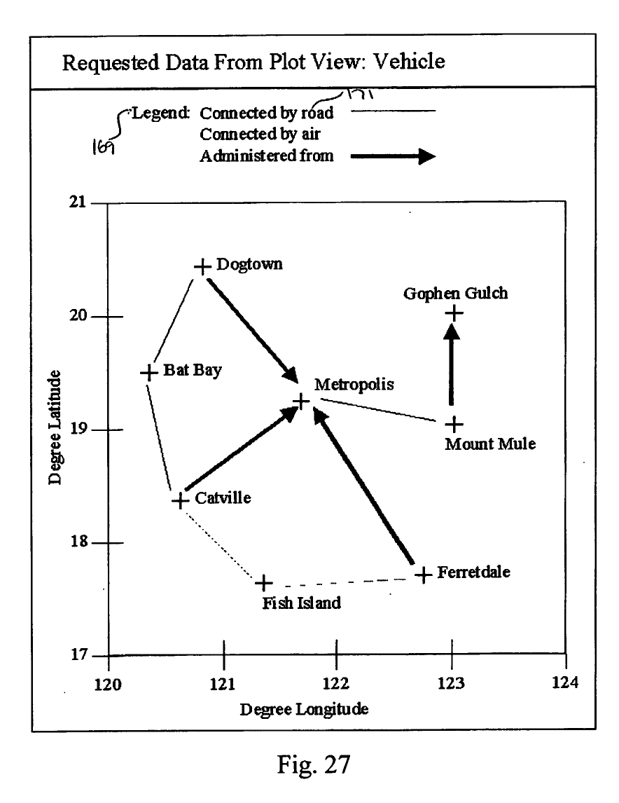

FIG. 27 shows a sample plot presentation 170;

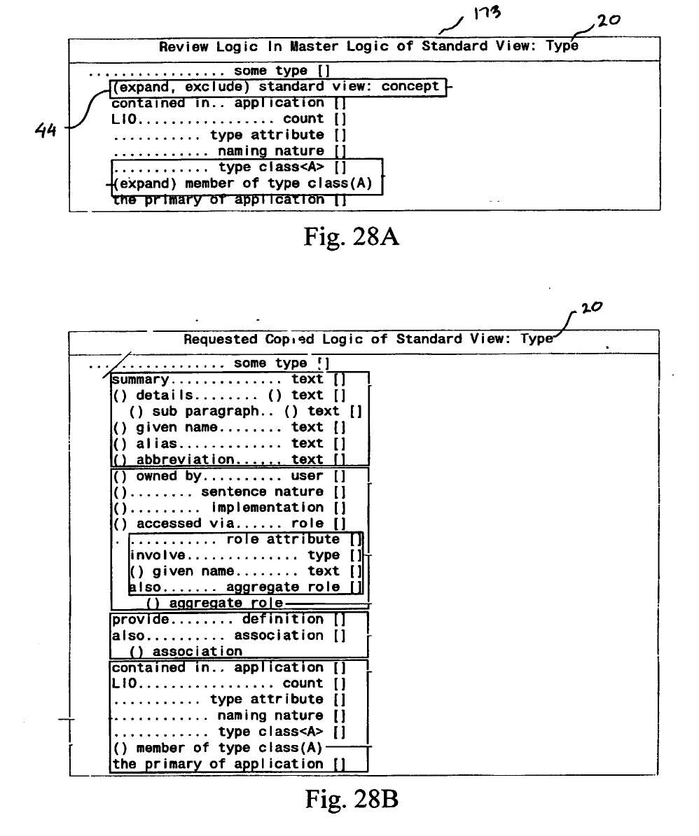

FIG. 28(a) shows the master logic 157 of a Standard View 173;

FIG. 28(b) shows the copied logic of the Master Logic of the standard view of FIG. 28(a);

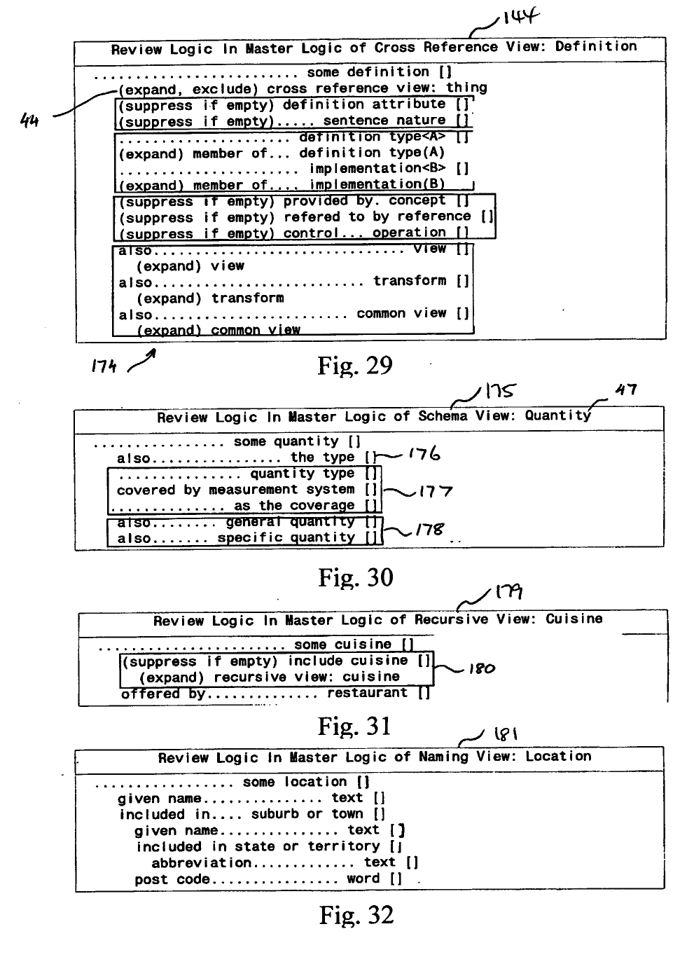

FIG. 29 shows a sample logic of the cross-reference view 174;

FIG. 30 shows the sample logic of a schema view 175;

FIG. 31 shows the sample logic of a recursive view 179;

FIG. 32 shows the sample logic of a naming view 181;

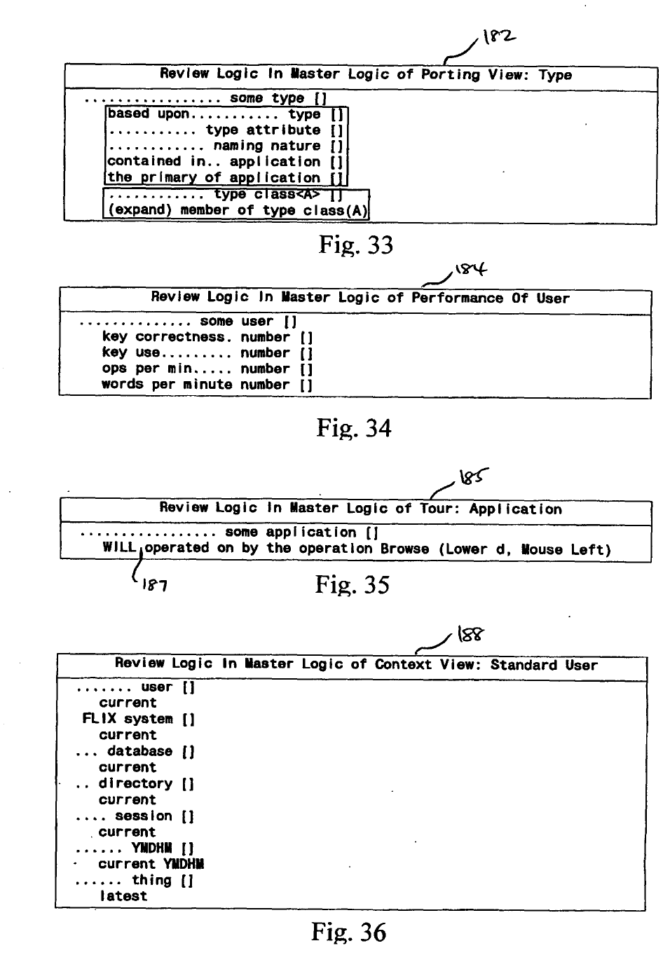

FIG. 33 shows the sample logic of a Porting View 182;

FIG. 34 shows the sample logic of a Named View 183;

FIG. 35 shows the sample logic of a Tour 185;

FIG. 36 shows the sample logic of a Context View 188;

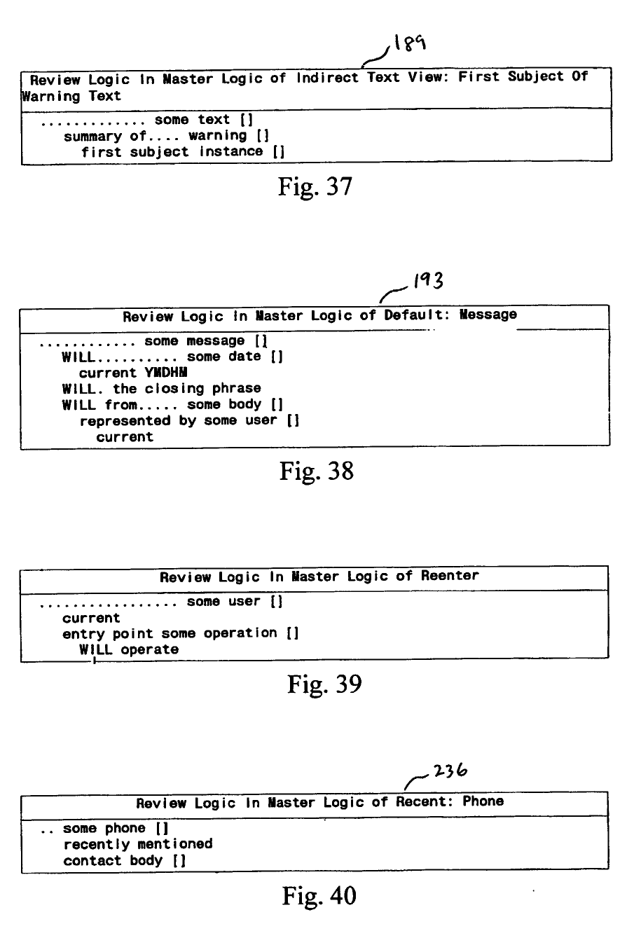

FIG. 37 shows the sample logic of an Indirect Text View 189;

FIG. 38 shows the sample logic of a Default 193;

FIG. 39 shows the sample logic of a Logical Command 219;

FIG. 40 shows the sample logic of a Recent Definition 236;

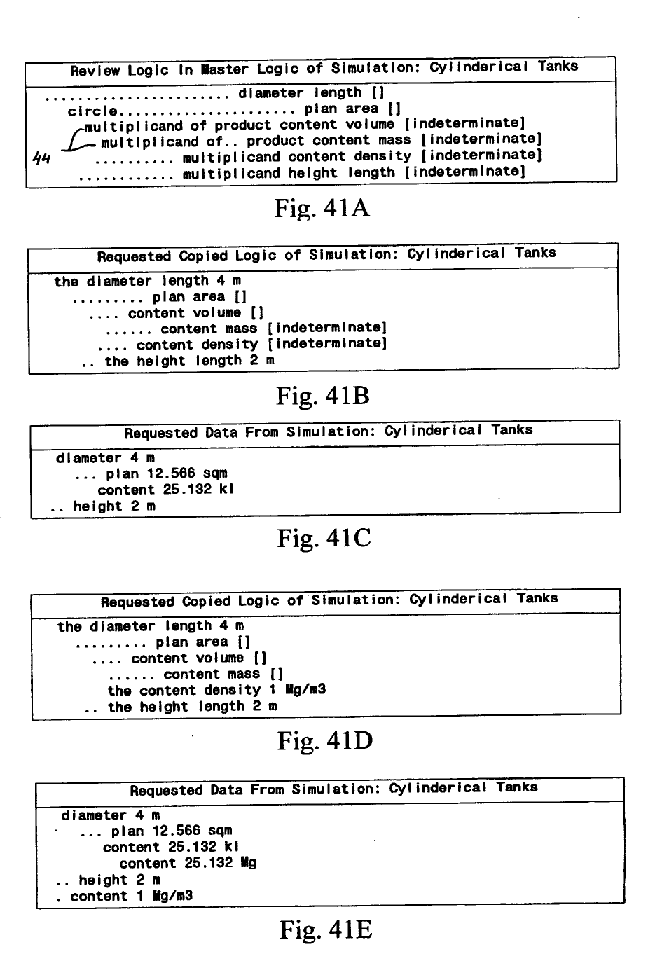

FIG. 41(a) shows the master logic 157 of a sample Simulation 190 relating to cylindrical tanks;

FIG. 41(b) shows the copied logic 158 of the sample Simulation of FIG. 41a;

FIG. 41(c) shows the requested data from the simulation of FIG. 41a;

FIG. 41(d) shows the copied logic of FIG. 41b with the data of FIG. 41c inserted;

FIG. 41(e) shows the data of FIG. 41c with the volume content and mass content automatically calculated and inserted;

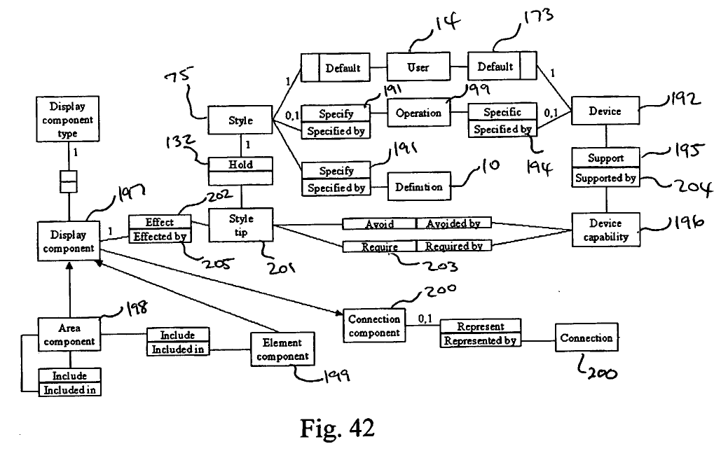

FIG. 42 is a flow diagram illustrating the Concept Net 1 of Styles 75;

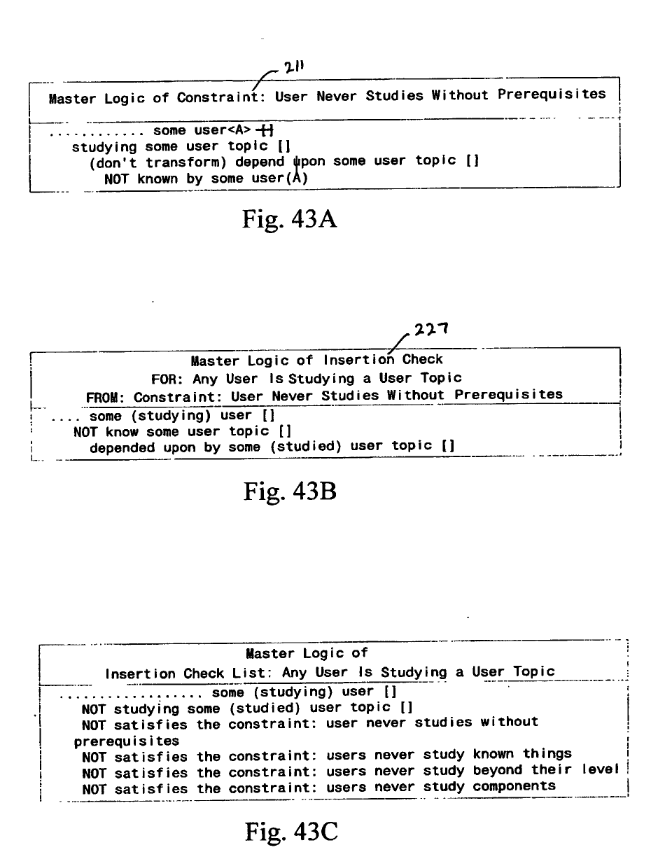

FIG. 43(a) shows the master logic of the constraint “User Never Studies Without Pre-requisites”;

FIG. 43(b) is the master logic of the insertion check 227 corresponding to the constraint 211 of FIG. 43a;

FIG. 43(c) shows the master logic 157 of the insertion check list 229 for “Any User is Studying a User Topic”.

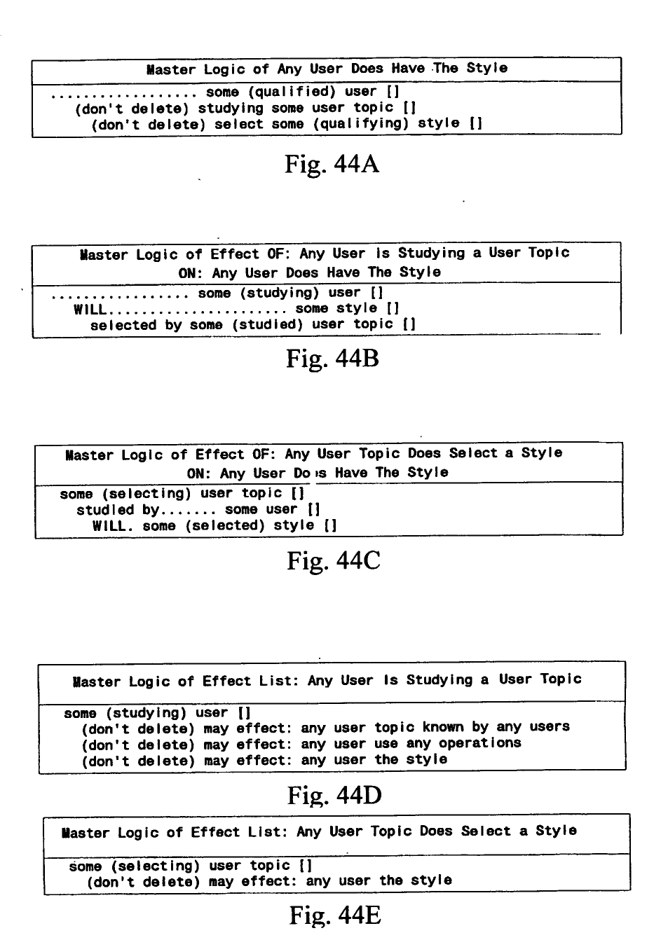

FIG. 44(a) shows a sample of a Logical Enumeration 212;

FIG. 44(b) and (c) show the two Effects 202 which flow from the Logical Enumeration 212 of FIG. 44(a);

FIG. 44(d) and (e) show all the possible effects of inserting or deleting an Association, 21 summarised in two Effect Lists 234;

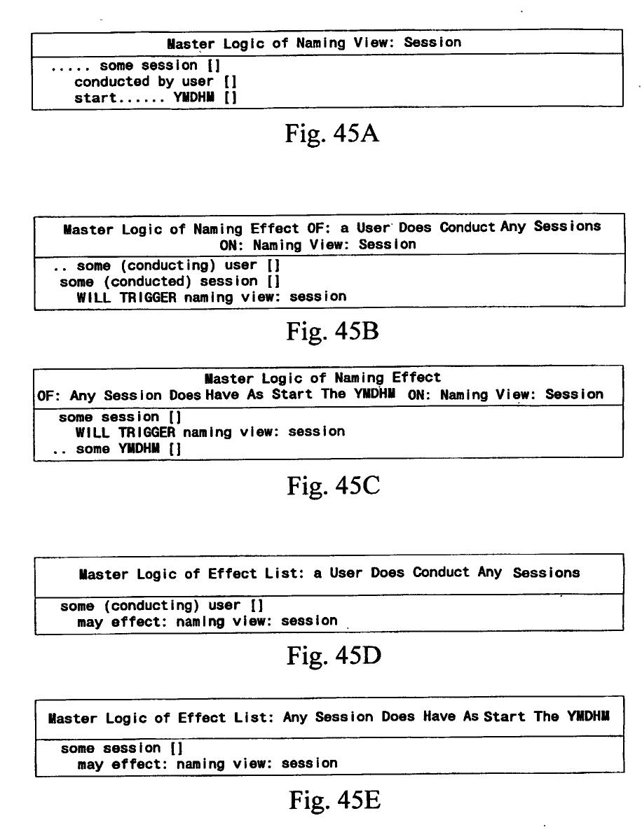

FIG. 45(a) shows the Logical Enumeration 212 of a Naming View 181;

FIG. 45(b) and (c) show the two Naming Effects 235 into which the Naming View 181 of FIG. 45(a) is transformed;

FIG. 45(d) and (e) show the Effects Lists which reference the naming effects of FIGS. 45(b) and 45(c) respectively;

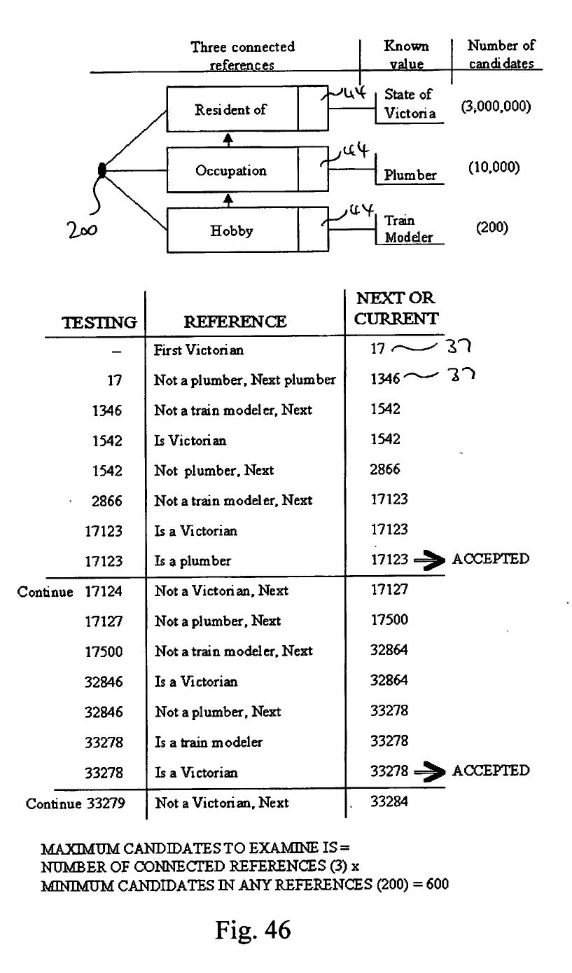

FIG. 46 is a flow diagram illustrating the way in which information is stored and searched, with reference to an intersection example; and

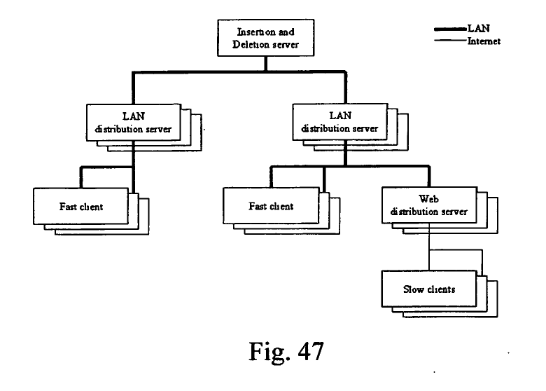

FIG. 47 is a flow diagram illustrating a typical server hierarchy of the preferred embodiment of the present invention.

### OVERALL STRUCTURE

Referring to the drawings, FIG. 12 is a flow diagram illustrating the overall structure of the preferred embodiment of the present invention. As seen in that Figure, the invention includes a concept net 1, a universal logic 2, a logical external interface 3 and a user action system. These four elements interact with one another in order to produce an information system which stores and retrieves information in a way that is readily understandable by humans and is readily extensible without the need for specific programming expertise.

The concept net has a number of elements and generally serves the purpose of organising the storage of data in the information system. It defines how the various elements and units of data relate to one another and is designed to minimise the complexity in the other elements of the system.

The universal logic refers to the concept net, presents the data via three kinds of phrases, and provides them to the logical external interface 3. This interface displays the phrases received from the universal logic in two kinds of display, namely a logical display and a data display. This interface implements a standard way of presenting all of the different kinds of data defined in the concept net.

The user action system 4 uses a set of operations to interact with the logical external interface 3. These operations allow a user to view data, enter data, create new kinds of data and perform many other functions. When creating new kinds of data and relationships between data, the user action system impacts upon the concept net, expanding it to include the newly created data types. More specific details of each of these four major elements of the invention are described below.

Concept Net (1)

FIG. 13 shows the major elements which make up the concept net, displayed in an hierarchical form. It is important to note that the overall concept net 1 is made up of a myriad of smaller interconnecting concept nets which organise the storage of particular kinds of data. The concept net described below defines ways of organising fairly general kinds of data. It will be appreciated by those skilled in the art that additional concept nets may be used to create particular applications using the present invention.

Turning now to FIG. 13, the most generic elements of the overall concept net 1 are instances 5. Instances may be either numbers 6, ephemerals 7 or things 8. An instance 5 may be considered to be one of something. For example, an instance may be the dog called Fido, the person called Fred or the number 392. Further details defining the concept nets of numbers 6, ephemerals 7 and things 8 are provided below.

Numbers 6 are kinds of instance which do not need to be created by users in order for them to exist. The numbers concept net includes a number of sub-types 178 such as integer, positive number, numbers between 0 and 100, and the like. These sub-types can be added to if a particular application so requires. Further details about the way numbers are displayed can be seen below in the discussion of quantities and number units which are described with reference to FIGS. 17 and 18.

One of the programming considerations to take into account when defining numbers is that all numbers should preferably be stored as high precision reals. This is so that there is sufficient precision to handle very large numbers. By using high precision reals, the program developer does not need to make any decision about maximum values or precisions. Using high precision reals also facilitates the reorganisation of the numerical aspects of a particular application even when the application is being used and has already been populated with data.

The second major kind of instance 5 is ephemerals 7. The ephemeral type is needed to access data which exists outside of the database of the present invention. For example, in order to interact with existing database and word processor systems, the present invention defines word processor files and database files as ephemerals. Ephemerals 7 are referred to using textual links. In the case of a file, its textual link might be its file name, which allows the file to be referred to by the system.

As mentioned above, the three major elements of the concept net 1 of the information system are numbers 6, ephemerals 7 and things 8. Whilst numbers and ephemerals have a fairly narrow range of subtypes, things 8 encompass a much broader range of sub-types. Whilst numbers 6 are not created by a user 14 and ephemerals exist outside of the information system, things 8 do not exist until they are created by a user, as the system is populated.

Things 8 include definitions 10, roles 11, text 12, formal references 13, users 14 and many user defined types of thing. Each of these specific kinds of thing are described in detail below.

As soon as any thing 8 is created, the system allocates an internal identifier 37 which is unique within the system. In the preferred embodiment, the internal identifier 37 is an integer. For example, when a person known as Fred is created, that person is allocated an internal identifier of 2377. When the dog Fido is created, it is allocated the internal identifier 4533. When the system stores the fact that Fred owns Fido, it simply stores the fact that thing No. 2377 owns thing No. 4533. An important element of the internal identifiers 37 is that they are unique across the whole database, so as to avoid confusion and to maintain the integrity of the data. These internal identifiers 37 are never reused in the preferred embodiment. This is so that, even if a particular thing 8 is deleted, the history of that thing's existence can still be detected and an audit trail can be generated.

Unlike prior art systems, things 8 are not located in any particular container in the way that a word processor document is located in a directory or a folder. Instead, in this system, things exist in their own right and can be located and identified by any associations 21 that they are involved in. When programming the software for this invention, it is important to make the unique integer 118 that acts as the internal identifier 37 large enough to cater for the creation of as many things 8 as are needed throughout the life of the system. For example, a 32 bit integer will be large enough to allow 4 billion things to be created. This is the default size of the internal identifier 37 used in the preferred embodiment. However, other sized integers are envisaged, including but not limited to, 64 bit integers. In addition, the program that implements this information system should also define a convenient structure for holding instances 5 which are either numbers 6, ephemerals 7 or things 8. The section towards the bottom of this document entitled “Programming Considerations” discusses such storage mechanisms.

Returning to the diagrams, FIG. 14 shows a flow diagram illustrating the concept net 1 of things 8. In that diagram it can be seen that things 8 have a number of properties such as given names 119, aliases 120, summaries 121 and details 122. Each thing 8 has a positive integer 118 as its unique identifier 37. Each thing 8 is owned by 98 a particular user 14. The default position is that the thing 8 is owned by the user who created it. This is useful in auditing past actions as one of the security features of the system. In addition, each thing usually has a type 20. Types are discussed in detail below. Because things 8 have all of these broad attributes, when particular things are created they inherit all of these attributes. These attributes can be used to search for and identify particular things.

Turning now to definitions 10; FIG. 16 is a flow diagram illustrating the concept net 1 of definitions 10. In that Figure, and in many other of the Figures in this specification, lines with arrows point from a sub-type 178 to a super-type 176. In this example it can be seen that definitions 10 are sub-types of the super-type thing 8. Divided boxes indicate associations between types. In FIG. 16, the type definition 10 is related to the role type by an “access/accessed via” association 16. Whilst further details of associations are described below, this association means that a definition 10 is accessed by a role 11 and that role 11 accesses the definition 10.

As shown in FIG. 16, the definition 10 type has at least two sub-types 178. These are the concept 17 and command 18 sub-types. Although not shown in FIG. 16, the definition 10 type also has a sub-type called view 19 which determines the way in which information is presented.

When creating a new application using the present invention, the application developer generally does so by creating new definitions 10. In the preferred embodiment only certain users will be permitted to create new definitions. Typically these will be experienced users who have been trained to reach a user level 102 called “developer level”.

Definitions 10 each have a definition type 22 which identifies the sub-type of definition that the definition belongs to. Definitions also have a sentence nature 23. The sentence nature 23 of a definition 10 is used to determine how the name of that particular definition, and the name of its roles 11 are displayed via the logical external interface 3. For example, the name of a definition may appear in the column headings of a table. It is important that users not be allowed to substitute arbitrary text where this definition name should appear. Concepts 17 are definitions 10 which organise the storage of information. Concepts 17 use more sentence natures 23 than other definition types 27. Some of the more common sentence natures 23 include transitive sentence natures, noun attributive sentence natures, classifying sentence natures and bi-noun sentence natures. An example of a transitive sentence nature is “a person does OWN some dogs/a dog is OWNED BY a person”. An example of a noun attributive sentence nature is “a letter does have as SUBJECT a thing/a thing may be the SUBJECT of any letters”. An example of a classifying sentence nature is “a person does have a profession/a profession does qualify a person”. An example of a bi noun sentence nature is “a male does have a WIFE female/a female does have a HUSBAND male”.

As shown in FIG. 16 roles 11 are the doorways to definitions. Instances 5 are passed to and from definitions 10 via roles 11. Some definitions have only one role, whilst other definitions will have two or more roles. For example, a definition such as “a dog” has only one role, whereas the definition “a person does own dogs” has two roles. Roles 11 have role attributes 24 which control a number of aspects of the way in which the definition behaves. Some of the more important role attributes 24 include mandatory role attributes, unique role attributes, aggregate role attributes, owner override attributes and ordered by insertion attributes. Examples of each of these kinds of role attributes are provided below. If the role “person owns dog” is a mandatory role attribute, then each dog must have a corresponding owning person. As such, a role which has a mandatory role attribute 24 must yield at least one value. If the role “person owns dog” is a unique role attribute, then each dog may only have one owner. As such, a role which has a unique role attribute cannot yield more than one value. An aggregate role attribute allows values such as total, least greatest, count, mean, standard deviation and the like to be specified. In order to appreciate the owner override role attribute it must be understood that a user whointially creates a particular value, such as the person Fred “owns” that value. It should also be understood that certain parts of the program can only be altered by users with particular permissions. The owner override role attribute means that even if a particular user does not have the general permission to change “dog ownerships” they still have the permission to change that role for the people they have created. For example, if a user owns the person known as Fred, they are able to update the role known as “dogs owned by Fred” because of the owner override role attribute.

Referring to the “ordered by insertion” role attribute, this attribute determines the order in which information is presented. If a particular role has the “ordered by insertion” attribute, then that attribute will determine the order in which information is displayed, regardless of whether that information is displayed out of alphabetical order. In this preferred embodiment, the order may be manipulated by the users and is typically used to order paragraphs of text. Text will be discussed later in this specification.

Still referring to FIG. 16, it can be seen that definitions 10 include concepts 17 and commands 18. Concepts are the kinds of definitions which are used in order to organise the concept net and to store data. Concepts 17 are divided into types 20 and associations 21. Concepts 17 may have zero, one or more concept attributes 25 including reflexive concept attributes, type concept attributes, insertable concept attributes, name indexing concept attributes and indirect concept attributes. A concept which has a reflexive concept attribute is one in which its two roles cannot be distinguished from one another. For example the concept known as “city connected to city” has a reflexive concept attribute because if Sydney is connected to Canberra, then Canberra must also be connected to Sydney. The “type” concept attribute is used to indicate that a particular, single-rolled concept 17 has a stable enough population for it to function as a type 20. Such stable concepts are able to be involved in the roles 11 of new associations. A number of single-rolled concepts 17, such as one known as “suspicious person”, may have populations which are rapidly changing and are therefore not suitable for the type concept attribute. The concept attribute known as an “insertable” concept attribute indicates that the logic behind the concept is so simple that the logic can be forceably satisfied without being ambiguous. The “name indexing” concept attribute indicates that a particular association 21 holds information that is conventionally used to identify a particular type 20 and should therefore be indexed in a similar way to the given name. Finally, an “indirect” concept attribute is a logical association which is automatically created in order to provide an indirect version of a particular association 21. For example, if a concept known as “a place may include other places” indicated that Australia includes Victoria and Victoria includes Melbourne, then the indirect concept attribute would indicate that Australia would indirecdy include Melbourne.

In order to more clearly understand the types 20 and associations 21 illustrated in FIG. 16 it may be useful to refer to the example shown in FIG. 3. In general terms, most human communication may be broken down into a very general form of clause such as “the person Fred does own the dog Fido”. This general form of clause, when cascaded and modified is able to take the form of questions, statements and commands. By breaking human communication down into these elements a logical way of organising an information structure emerges. The present invention is grounded upon the division of information into types, members and associations. An example of a type is “person” or “dog”. An example of members of these types include “Fred” and “Fido”. Associations relate particular members to one another. In this example the association which relate Fred and Fido may be “does own” or conversely “is owned by”. Types 20 exist in order to allow their members 26 to be referred to as a group. Associations 21 allow the members 26 of specific types 20 to be related to one another. Associations 21 which involve a particular type 20 may provide the properties or attributes of that type 20. Referring to FIG. 3 it can be seen that the types 20, person 27, dog 28 and project 29 are all sub-types of the general type thing 8. In that Figure, members 26 of particular types 20 are indicate by a curved line ending in a dot. For example, Fred 30 is a member of the type known as person 27. Fido 31 is a member of the type known as dog 28. Associations 21 in FIG. 3 are indicated by a divided box. The association known as own/owned by 32 relates Fred 30 and Fido 31 to one another. In this example the association 32 specifies that Fred owns Fido and Fido is owned by Fred. In the preferred embodiment, such associations always operate in two directions. In this way, one can easily proceed from a person to the dog they own or from the dog to the person who owns it. Similarly, if a letter is sent to Fred, then that letter can be located as being one of the letters which was sent to Fred.

Because of the fundamental nature of types 20 and associations 21 it is possible to organise and store all information needed for this information system as a type or as an association. In the preferred embodiment, one of the files stores the high speed data for each thing 8 and the other file stores the high volume data for each association 21. The high speed file consists of a number of variable length data records 36, each record having a corresponding unique internal identifier 37. One disk access can retrieve the entire record for the thing which stores the properties of the thing 8 that are not too voluminous. The high volume file 38 contains a number of B-tree records 39 which are all the same length. One disk access will retrieve a B-tree record 39 which will contain part of the population of an Association 80. The high volume file basically consists of a set of two-column tables with entries which define the association. For example, the association known as “borrows/is borrowed by” 40 would be represented by an entry in the two-colum table, one of which was book and the other which was person. This would indicate that the association relates books to people.

In practice there are thousands and thousands of different types 20 and associations 21 which need to be used. The present invention therefore provided the facility for users to create new types 20 and associations 21 just as easily as they can create new members 26 of existing types 20. In fact, since Fido 31 is a member 26 of the type known as dog 28 and the type known as dog 28 is itself a member of the type known as animal, this suggests that the same operations used to create a member of a type may also be used to create the type itself. This ease of creation has been implemented in the present invention and is one of the features which makes it adaptable to so many different applications.

Returning to FIG. 13 it is clear that concepts 17 organise the knowledge within the information system and this knowledge is divided into types 20 and associations 21. The types define a group of members 26 and the associations 21 relate the members 26 to one another. As shown in FIGS. 16, types 20 have type attributes 41 and each type has a type class.

The type attributes 41 include zero or more of the following:

(a) Has Type: When this attribute is applied to the type known as “dog” 28 it would automatically create a new type known as “dog type” which indicates the breed of the dog. It would also automatically create an association 21 known as “a dog may have a dog type”;

(b) Has Attributes: When this type attribute is applied to the type known as dog 28, it would cause the automatic creation of a new type known as “dog attribute” and the creation of an enumeration 43 known as “any dog may have any dog attributes”. This would then allow particular dog attributes to be created as necessary. These attributes might include “persistent barker”, “obedience trained” and the like.

(c) Instances Ordered: This type attribute is used for sequentially numbering new members 26 of particular types 20. When a new member 26 is created, it is automatically allocated the next available integer. This type attribute may be used for sequentially numbering letters, purchase orders and the like;

(d) Closed: This type attribute indicates that it is unlikely that any new members 26 of this particular type 20 are going to be created. When a user selects from a type which has the “closed” type attribute, then rather than just displaying the members which were recently viewed by the user, the entire set of members is presented. Because the type has the type attribute known as “closed” the membership is limited and not infinite;

(e) Raises Sub-Types: If this type attribute is applied to a type 28 it automatically creates a new sub-type of “dog” 28 whenever a new dog type is created. When a type has this type attribute, the role attribute of its association is marked as “sub-typing”;

(f) System Populated: New members 26 of a type 20 which has this type attribute are automatically created by the system and are not created by end users. Examples of types 20 which have this attribute are known as “sessions” 94 and “alternative roles” 135;

(g) Don't Inherit: This attribute prevents the automatic insertion of a reference 44 into the standard view 173 that causes the inheritance of properties from the direct and indirect supertypes 176;

(h) Limited Creation: Types 20 which have this attribute 41 may only have new members 26 created by certain permitted users. These users are preferably indicated by an association known as “may create”;

(i) Lockable: This type attribute 41 is used when the system is accessible to a number of different users. The members of this particular type will be locked whenever their owner (first creator) is in the process of modifying them. The types which are most commonly lockable are definitions and paragraphs of text (explained below); and

(j) Omit Prefix: Since the full names of some types 20 contain prefixes, the prefix can be omitted by using this type attribute 41. For example, the fill name of a member 26 of the type 20 known as “phone” might be “phone: 01 2987 6543”. If the omit prefix attribute 41 was set, then, when displayed, that particular member 26 would appear as “01 2987 6543”. In this case “phone:” is the prefix.

Still referring to FIG. 16, each type 20 has a type class 42. Each type must have a type class and, in the preferred embodiment, this class may be any one of the following classes:

(a) Enumerated Types: The type class known as “enumerated types” includes those whose members 26 may be inserted and deleted directly. This type class is very rare, as it is usually better to use Has Type or Has Attributes. This type class applies to most information that a user would insert, delete and access in the information system. When initially supplied, the information system of the present invention would probably not include any enumerated types in its database, so that the end user could add their own information.

(b) Types of Thing: The type class known as “type of thing” applies to any type that is a direct sub-type of a thing 8 and is distinct from all other sorts of thing 8. For example, an invoice is a direct sub-type of a financial transaction. In this case the type known as financial transaction would have the type class “type of thing” while the type known as invoice would not be a “type of thing”;

(c) Contained Types: The type class known as a “contained type” applies to those types 20 which are physically within a container 45. Members of contained types are identified by the name of their container followed by full stop and their order within that container. For example, a line item 46 may be physically stored within purchase order No. 3345. In order to identify that line item, it would be referred to as “3345.1”, as the first line item, “3345.2” as second line item 46 and so on. One of the features of a contained type is that, when the container is destroyed, everything within the container is also destroyed. Storing information in this method results in a physical clustering of information that allows very rapid access to that information;

(d) Simple Sub-Types: The type class known as a “simple sub-type” is a type 20 whose members 26 possess a particular value of a particular property. For example if there was a type 20 known as “dog type” then a sub-type might be Corgi. The Corgi sub-type is defined by the fact that the dog type property has the particular value of “Corgi”;

(e) Quantities: The type class known as “quantities” applies to those types which are used to organise numeric units and to allow numbers 6 to be displayed in different measurement systems for different users 14. Some examples of quantities are length, mass and duration. As well as these general quantities 47, there can be more specific quantities such as water depth. FIG. 17 shows a concept net which describes quantities 47. It can be seen from that Figure that quantities 47 are sub-types of types 20. It can also be seen from that figure that the quantity known as “length” is a subtype of the type known as “number”. Quantities consist of specific quantities 48 and general quantities 49. Specific quantities 48 have members 26 which include water depth 50, horse height 41 and the like. General quantities 49 have members 26 which include length 42, mass 53 and volume 54. General quantities 47 each have a unique general quantity type 55 whose members 26 include base 56, derived 57 and supplementary 58. An example of a supplementary general quantity type is a monetary value. General quantities 49 may have upper limits 59, lower limits 60 and dimensions 61. As shown in FIG. 17 a quantity 47 may have a particular measurement system 62 whose members 26 include the metric measurement system 63 and the imperial measurement system 64. Quantities 47 may be displayed according to particular number conventions 65 and those number conventions may have number convention attributes 66;

(f) Numeric Units: As shown in FIGS. 17 and 18 the type class known as a “numeric unit” 67 applies to those types which represent a unit of measurement for some quantity 47. Examples of numeric units are grams, litres and metres. As shown in FIG. 18, numeric units 67 may be primary units 68 whose members 26 include metres and seconds. These primary units are those in which data is stored or calculated. Numeric units 67 may also be secondary units 69 whose members include foot and pound. These secondary units provide automatic conversion to the underlying primary unit 68. Numeric units 67 may also include compound units 70 whose members include sets such as hour, minute, second and mile, yard. Numeric units 67 also include irregular time units 71. Irregular time units 71 are those which represent absolute points in time and include formats such as year formats, month formats, day formats, time of day formats and the like. Numeric units 67, quantities 47 and measurement systems 62 are related to one another in a fairly circular fashion. A measurement system 62 may specify a particular numeric unit 67 to be used for every known quantity 47. In turn, a measurement system 62 may be spawned from another measurement system and may therefore only specify those particular quantities 47 that differ from its parent measurement system;

(g) Primitive Types: The type class known as “primitive types” apply to those types which are created when programming the software of the present invention, rather than during operation of the system by a user. Examples of primitive types are instance 5, thing 8, number 6, ephemeral 7, file 34, directory, database, disk drive and leap year;

(h) Numeric Constants: The type class known as “numeric constants” applies to those types that define a particular number. An example of a numeric constants is the number Pi; and

(i) Complex Sub-Types: The type class known as “complex sub-types” applies to those types whose logic is more complicated than that of a simple sub-type. This kind of class is used to group complicated sub-types without involving any new associations 21.

Returning to FIG. 13, the above description has included many of the elements within the overall concept net shown in that Figure. We have already discussed numbers 6, ephemerals 7, things 8, roles 11 and definitions 10. Within the topic of definitions we have discussed concepts 17 which include associations 21 and types 20, and we have discussed the different attributes 41 and classes 42 that a type 20 have. The remaining types of thing needed to be described are text 12, formal references 13, users 14, and some others relating to history 15.

Beginning first with text 12, FIG. 15 shows the text concept net. As shown in that Figure text 12, as with most other creatable elements of this information system, is a sub-type of things 8, the most general grouping in the general information system. A piece of text 12 may be as small as a single character or may be as large as a long paragraph. Text 12 is made up of words 74 and formal references 13, separated by single spaces. On a higher level, larger groupings of text are assembled using associations 21. In contrast to prior art word processor systems, the present invention does not group and store text in files, but each element of a piece of text, whether it be a word, character or whole paragraph is separately stored and individually identifiable. This conceptual shift is needed to fully understand the flexibility and searchability of this information system.

Since a paragraph of text 12 may cover a number of topics or subjects, each of which may be classified as a separate thing 8, that paragraph may need to be displayed in a number of different contexts. As such, text 12 only stores the information required to make up the text, and does not store formatting information. When a user wants to display a particular piece of text, the format of the text is influenced by styles 75 which come into play when displaying that piece of text. Styles will be discussed in more detail with reference to the logical external interface 3.

Because text 12 is a sub-type of thing 8, it inherits many of the properties of things 8. Relevant properties to text are:

(a) Paragraphs have given names which are inherited from their corresponding things 8;

(b) Hierarchical paragraphs may include details as to their structure which are inherited from their corresponding things 8. The association 21 known as “details” allows paragraphs to have subordinate or sub-paragraphs;

(c) Standard paragraphs can be identified by abbreviations so that they can be readily identified and included just by entering the abbreviation;

(d) Pieces of text may be related to one another using the association known as “loosely contained in”; and

(e) Piece of text can be located when it's name is not precisely known by using the association “loosely name”.

As mentioned above, text 12 consists of words 74 and formal references 13 separated by spaces. Formal references 13 are basically names of particular things 8. When a formal reference is displayed it is done in such a way that a user can see that when they select that formal reference, they will be taken to more particular information about that thing. This operates in a similar way to hypertext linking used in HTML, and allows information in this system to be browsable to an almost unlimited extent. For example, a paragraph which includes the formal reference 13 Fido allows browsing to any other reference to Fido in the system, as well as to Fido's owner details, or the attributes of its particular dog type. Each of those pieces of information which relate to Fido can also be browsed in the same fashion. In order to enable a formal reference 13 to blend into a paragraph it may have enclosing attributes 76 or more general attributes 77. Examples of enclosing attributes are “enclose in brackets” or “enclose in quotes”. General attributes 77 include displaying the structures such as pluralise (which apply the plural form of the word if appropriate to the context), append its type (which displays the information in the form “member:type”, such as “Fido:dog”), prepend its type (which is similar to append but in the reverse order, that is, “type:member”), gerundise, remove preposition, capitalise, abbreviate and the like.

When programming the information system of the present invention it is important to indude a small non-textual element within the text in order to identify the position of a formal reference 13. This small element would contain a non-text sentinal and an integer internally used for identification by the program.

As shown in FIG. 15, words 74 are kinds of text 12 that contain no spaces. Words may be subdivided into various word types 78 such as proper word 79, misspelling 80, suffix 81, character 73, word root 82, abbreviation 83, file name 84 and file extension 85. Word roots 82 are the part of the word that remains once the longest possible suffix has been removed. Some of these word types 78 may be added to if particular applications require. Proper words 79 are the correct spelling of real words, as opposed to made-up or misspelled words.

As shown in FIG. 15 words 74 are contained in 86, every piece of text 12 in which that words occurs. Conversely, piece of text 12 contains 87 a number of words 74. In this way, a paragraph can be identified from any of the words that it contains. In addition, a proper word 79 partially names 88 or things 8 that that word occurs within. Conversely, things 8 may be partially named by 89 a proper word. For example the thing 8 known as “woodworking tools” is partially named by 89 the proper word 79 known as “tools”. Associations 21 such as partally names 88 and contained in 86 allow the system to identify different things 8 from loosely typed text and enable very extensive queries to be posed. In a similar way word roots 82 and suffixes 81 can also be used to identify particular things 8 from loosely typed text.

As shown in FIG. 15, a proper word 79 may loosely spell 90 some other proper word 79 that shares the same word toot 82. Proper words 79 may also partially name 88 things 8 which share the same word root 82, as mentioned above. Proper words 79 may also perform some lexical function 91 in order to more correctly incorporate a word into a sentence. These lexical functions 91 include:

(a) Articles: An article may be automatically added to a formal reference 13 if appropriate,

(b) Prepositions: These may be used to determine whether a particular transitive concept has an active or passive role;

(c) Pronoun;

(d) Digit;

(e) Auxiliary; or

(f) Connective.

When developing the software for this information system, the preferred embodiment uses an internal identifier in order to locate a word given the characters of its spelling. This internal identifier is held in a concealed, ordered store. In this way, instead of having to represent a particular spelling by the characters themselves, a word can be identified by its internal identifier.

Returning to FIG. 13, history 15 is used in order to create an audit trail which shows when a user has a created, modified or removed information in the system. History is made up of facts 92, deletions 93 and sessions 94. As shown in FIG. 19, a fact 92 records when an enumerated association is inserted into. It not only records details about when and by whom the insertion was typed in 95 but also that the particular fact 92 was related 96 to two particular instances 5. When a particular fact is deleted, this fact 92 feature is the only way of confirming that that information existed.

When programming the facility to store facts 92 in this information system, the two ordered stores which hold the enumerations must have two keys which represent the inserted instances 5 and a third key which represents the fact 92. The act of identifying a pair of inserted instances 5 once a fact is known should be handled by a separate, system populated, enumeration which is known as “a fact does relate some (two) instances”. This particular enumeration will be unfacted but is efficiently implemented in both directions.

Deletions 93 record the deletion of a particular fact 92.

Sessions 94 record the changes that a user makes to the information system. Sessions are created automatically and are identified by user 14 and start time. As such, a session has start times and end times and is conducted by 96 a user, also shown in FIG. 19. The session 93 inserts 97 things 8 that were created by (or owned by) 98 the user 14. The sessions not only record the creator of things, they also include facts and deletions.

Referring to FIG. 13, the final kind of thing to be discussed is users 14. Users are the kind of thing 8 that operates the systems. FIG. 20 is a sample display which illustrates the properties of a user 14. As seen in that Figure, a user may have an operation 99 which is an entry point 100. Such an operation 99 will typically control the kind of display 101 which is presented to the user when it logs onto the system. A user 14 will also have a user level 102. The user level is used by the security facility in order to determine those parts of the system which the user has access to and those parts of information the user is able to modify. In this preferred embodiment the user levels include browser, worker, developer, and supervisor. The system may include a concept net, definitions and database training facility which enables the user to progress through the different user levels. As they do so, they receive broader access permissions and an increased range of operations which they can use. Users 14 also have operating preferences which indicate the particular ways in which the user likes the system to operate. Some operating preferences include correct misspellings (which automatically corrects the misspelling of words), short operation names (which allows the user to refer to operations by shortened names), omit speed keys (which allows a dedicated mouse user to suppress the names of shortcut keys in operation names), do not disturb (which prevents a user from receiving an audible warning of interruptions by other users), simple reject (which omits elaborate explanation of why the operation invoked by the last keypress was rejected) and the like. A user may have a default style 104 which influences the presentation and formatting of the displays 101 presented to the user 14. The user will also have a palette 105 which specifies a particular colour for different elements shown on the display 105. The user may also have a screen width 106 which is specified in terms of a particular length 107. This is used to ensure that a particular font size will remain correct even when the screen resolution is changed. A user 14 may also have a default print device 108 and a help operation 109. The help operation in the preferred embodiment is invoked by the F1 key. Each user 14 will have a number of operations 99 available to them. This list will start off small, as the user is a browser and will increase as new operations are learned during the training course and as the user proceeds up the user levels 102.

Because a typical information system will have a large number of users, each having varying degrees of abilities, the preferred embodiment includes a number of security features 214 in order to ensure that unauthorised users do not change, delete or add information that they are not supposed to. FIG. 21 is a flow diagram illustrating the concept net 1 of the security features 214 of the preferred embodiment of the present invention. These security features relate to those aspects which may be modified by users, as opposed to the fundamental building blocks of the system which have been created by the programmers and which cannot be changed by individual users. The security features exist at a number of levels, namely:

(a) Log On Based Security: In one embodiment, the information system may be configured to require the user 14 to supply a password in order to log on. Any failed attempts are recorded by the system;

(b) Accountability Based Security: Because the system is able to detect the identity of the user that inserted or deleted any enumeration 43, there is a certain amount of inherent security in this kind of accountability;

(c) Skill Based Security: Because of the implementation of user levels, inexperienced and insufficiently trained users are not provided access to dangerous and powerful operations;

(d) Classification Based Security: As shown in FIG. 21, things 8 are provided with security classifications 111. Users 14 are also provided with security classifications 111. If a particular thing 8 has a higher security classification than 111 than a user 14, then that user is not provided with access to that thing 8; and

(e) Concept Based Security: As shown in FIG. 21, users 14 are allowed to access 112 all those enumerations 43 which do not have the enumeration attribute 113 which is known as “limited access” 114 or “limited change” 115. In addition, if a particular type 20 has the type attribute 41 known as “limited creator” then only certain users 14 are permitted to add new members 26 of that type 20. If a particular thing 8 has a role 11 whose role attributes include “owner override” then the user 14 who created that thing (or owns that thing) is able to modify that thing 8 even if that user 14 may lack permission to modify other similar things. That is, if a user creates a person known as Fred, then they are deemed to own Fred and they are therefore permitted to update some of Fred's associations, such as the dogs which Fred owns, provided that that particular association has the role attribute 24 known as “owner override”. Although a user 14 may have access 112 to a particular enumeration 43, this does not overrule the more general security classifications. Furthermore, a user 14 may be allowed to change 116 a particular enumeration 43.

Returning to FIG. 12, as previously mentioned, the concepts net 1 organises the storage of data in the information system and defines how each of the different elements relate to one another. The logical external interface 3 provides a standard way of presenting all of the different kinds of information using two displays 101 called the logic display 124 and the data display 125. Because the information system of the present invention will, in practice, have a very large number of different kinds of thing 8 which a user 14 may want to store and retrieve, the inventors have come up with a universal logic 2 that interprets the concept net in a uniform way and presents the data via three kinds of phrases 126 which the logical external interface 3 uses to display the information. A discussion of this universal logic appears below, followed by a discussion of details of the logical external interface.

Universal Logic (2)

The concept net 1 is made up of types 20, sub-types and associations 21 that define a potentially complex web of data storage. The information system of the present invention needs to refer to this data for many purposes in order to provide its users 14 with the functionality they require. In order to fulfil this purpose, the inventors have devised a universal system of logic 2.

In FIG. 4 the information above the double line shows the association 21 known as “hate/hated by” 141. Above that association is the part of the concept net 1 which relates to that association 141. Below the double line is a set of references 44 and connections 131 which together define the logic 2 of the association 141. In this example the reference 44 called “dote on/doted on by” 142 refers to the association in the concept net known as “doted on by/dote on” 143. In the universal logic 2 the references 44 are linked by connections 131 into a network. The logic operates by finding an instance for each connection 131 such that all the references 44 that link them are satisfied. In the preferred embodiment, every association 21 provides convenient access into the types 20 which it relates. This access should be provided in both directions. For example, it is possible, using this invention to perform a search which finds the dogs which are owned by Fred as well as the persons which own Fido.

In this invention, the logic 2 is used for a large number of purposes such as defining:

(a) the members of a sub-type;

(b) the behaviour of logical associations;

(c) the view used to control a data display (discussed below with reference to the logical external interface);

(d) an ad hoc query;

(e) constraints on insertion and deletion;

(f) consequences of inserting and deleting;

(g) default values for new members of a type;

(h) data to be exported or imported;

(i) the behaviour of new commands; and

(j) how to form the full names of some things.

In the preferred embodiment, the universal logic is made up of definitions which have the implementation known as “logical”, enumerated, “primitive” and “programmed”.

The logical definitions 127 may be broken down into alternatives 129, references 44 and connections 131, as illustrated in FIG. 22. Because the universal logic 2 controls most dynamic aspects of the systems performance, it should be stored in a very compact and flexible manner. In the preferred embodiment, this compactness is achieved by storing the logic as types 20 which have the type class 42 known as “contained types”, mentioned above. As mentioned previously, members of contained types are identified by the name of their container followed by a full stop, and their order within that container. This storage method results in a physical clustering of information that allows very rapid access. The types 20 indicated in FIG. 22 with an asterisk indicate that they are contained types.

As well as being stored in a compact and flexible manner, the universal logic 2 should also be able to be queried, exported and imported in the same manner as all other information in the system. This allows the logic behind the system to be expanded and changed in order to cater for new applications.

As shown in FIG. 22, alternatives 129 are held in 132 logical definitions 127. Alternatives 129 exist to express the logic of “either/or” and “if/not/or”. In the preferred embodiment, every logical definition 127 holds 133 (or has) at least one alternative 129. However, the alternatives are not visible until there are two alternatives.

Each alternative 129 may hold 133 a number of references 44 to definitions 10. Alternatives 129 also hold 133 references 44 and connections 131. In turn, connections 131 connect 134 references 44 to each other and to alternative roles 135. When an alternative 129 is created, it automatically provides an alternative role 135 to correspond with each role 11 of its corresponding definition 10. These alternative roles 135 act as the “doors” between the internal universal logic 2 and any external references 44 to that logic.

As shown in FIG. 22, references 44 are held in 132 (or contained in) alternatives 129. References 44 refer to 136 definitions 10. When created, a reference 44 automatically provides a reference role 137 which corresponds with each role 11 of the definition 10 to which it refers. These reference roles 137 are then connected to 138 connection 131 in order to provide the structure for the universal logic 2.

There can be no direct connection between the logic of an alternative 129 and any other logic as it would make no sense. When the definition holding an alternative is referenced by a reference 44 in some other logic, there is a defacto connection between the reference roles of the outside reference and the alternative roles of the definition being referenced. If there is more than one alternative then the alternatives are connected up one at a time as required.

As also shown in FIG. 22, a reference 44 may also provide a factual role 139 if it refers to an enumeration 43 (discussed below) which is not “unfacted” (discussed below). A reference 44 may also provide an ordinal role 140 if one of its roles 11 has a role attribute 24 known as “ordered by insertion”. Factual roles and ordinal roles allow the reference 44 to behave in a more sophisticated manner when it is required, without having to complicate the nature of more common references 44.

References 44 may have reference attributes 140 which, in the preferred embodiment, include the following:

(a) Not: The universal logic 2 will only succeed for a reference 44 that has a reference attribute 140 of “not” if the values in question do not satisfy the reference.

(b) Will: The logic 2 must find values that do not currently satisfy a reference 44 that has this reference attribute 140. However, if the logic 2 is being forced, then the logic must find values to satisfy the reference on completion;

(c) Expand: This causes a reference 44 to a logical definition 127 to be expanded when viewed in the data display (explained later). References 44 which have this reference attribute 140 usually refer to viewing definitions 144 or named viewing definitions (explained later) and allow the group of properties to be conveniently referred to by one reference 44.

(d) Suppress If Empty: If a reference 44 having this reference attribute 140 does not yield any values, then the entire sequence of reference phrase 146, connection phrase 147 and instance phrase 148 should be omitted from the data display 125;

(e) Suppressed: A reference 44 which has this reference attribute 140 causes the text for its corresponding reference phrase 146 to be suppressed in the data display 125. However, the reference phrase 146 still exists and may be indicated by the cursor. This feature is used for decreasing the verbosity in presentation formats such as the memorandum format 150;

(f) Not In Tables: This sequence of reference, connection and instance phrases 146, 147, 148 will be omitted if the subject occurs more than once, as will commonly occur in a table. This allows the same logic 2 to present a detailed view when browsing to a particular subject but also to present a less detailed view when the information is presented in a table; and

(g) Not To Browsers: This sequence of reference phrases 146, connection phrases 147 and instance phrases 148 is omitted if the user 14 is only at the user level 102 known as “browser level”

Apart from alternatives 129 and references 44, the third component of logic is connections 131. As seen in FIG. 22, a connection 131 is a sort of thing 8 that is held in 132 an alternative 129. Connections 131 join reference roles 137, alternative roles 135, factual roles 139 and ordinal roles 140. Connections 131 therefore provide the structure of an inter-connection pattern of references 44.

Connections 131 involve 117 types 20. Such a corresponding type 20 specifies the sort of instance 5 which may occupy the connection 131. In order to determine this type 20, the system selects the most specific super type 178 of any role 11 which is joined to the connection 131. The selection of this particular type 20 may, however, be manually overridden. Connections 131 have connection attributes 242. Some of the more important connection attributes include:

(a) Mandatory: If a value cannot be found on a connection 131 that has this connection attribute 242, then the logic will fail;

(b) Unique: If more than one value can be found on a connection 131 that has this connection attribute 242, then the logic will also fail;

(c) No: If any value is found on a connection 131 that has this connection attribute, then the logic will fail;

(d) Group: The values yielded on a connection 131 that has this connection attribute 242 may be used to group other values appearing in the data display 125;

(e) Suppressed: The text in a connection 131 which has this connection attribute 242 is suppressed in order to reduce verbosity. This attribute is often used in styles 75 such as the memorandum style 150; and

(f) Stylised: A connection with has this connection attribute needs to have information added to it which relates to its layout, presentation and style.

Apart from logical definitions 127 and primitive definitions 128, there are enumerations 43. FIG. 21 shows that an enumeration is a sort of concept 17. Enumerations 43 have two roles and have the implementation 243 known as “enumerated”.

Enumerations 43 are very important in this information system, as almost all information is stored in enumerations. The only information not stored in enumerations are the characters 73 in a piece of text 12.

Enumerations 43 are implemented by using two ordered stores, namely a high speed store 245 and a high volume store 246. All the high speed stores are contained within the previously mentioned high speed file and the high volume stores are contained within the high volume file. One particular use of the high speed store is to store logic 2. The high speed store is used to store things 8 in normal applications which have the role attribute 24 of “few”. The high speed store 245 needs to have this high speed retrieval of logic 2 because it controls most of the dynamic behaviour of the system and, in particular, the response time. In the preferred embodiment, this high speed store 245 stores each thing 8 in a variable length record 36. This record holds a list of links for each enumeration 43 if the population is small. The variable length record may also use a bit mapped set if the population is known to be small. Alternatively, if the value is unique, the variable length record 36 may include an ordinal value 247.

The high volume store 246 is designed to handle large quantities of information. In the preferred embodiment this is implemented using B-trees 39.

As shown in FIG. 21, an enumeration 43 may have a number of enumeration attributes 113 including any of

(a) Unfacted: An enumeration which has this attribute 113 does not contain facts. This saves storage time and most enumerations 43 concerning logic have this attribute. However, it is not possible for an unfacted enumeration to be retrospectively nested on by a nesting type and there is less ability to track changes made to such an enumeration;

(b) System Populated: An enumeration which has this attribute is populated automatically by the system and cannot be changed by users 14;

(c) Limited Access 114: An enumeration 43 which has this enumeration attribute 113 may only be accessed by users 14 who have specific permission to do so; and

(d) Limited Change 115: Similarly, an enumeration 43 which has this attribute may only be changed by users 14 which have permission to do so.

Apart from logical definitions 127 and enumerations 43, there are primitive definitions 128. Primitive definitions are definitions 10 which have the implementation 243 known as “primitive”. Primitive definitions are implemented by the underlying program and cannot be created by users. Further discussion of primitive definitions can be found in the section describing primitive types and operations 99. Primitive definitions 128 may either be concepts 17 or commands 18 but cannot be any other kind of definition.

The major kinds of primitive concepts are specials 248, numeric primitive definitions 249, arithmetic primitive definitions 250, approximate primitive definitions 251, cycling primitive definitions 252 and file system primitive definitions 253.

Turning firstly to special primitive definitions 248, these affect the interpretation of the logic 2 in irregular ways. Examples of specials 48 are:

(a) An instance is also an instance: This is true if the same instance 5 exists on both roles 11. It is often used with the reference attribute 140 of “not” in order to ensure that two connections 131 do not yield the same value. It is also used in relation to views 19 to implement a more restrictive sub-type 178 on a particular role 11. This causes the view to be expanded with the inherited associations 21 of the sub-type 78 only if it is a member 26. However, if it is not a member, then this portion of the logic fails;

(b) Any instance is a member of any types: This special 248 is used in relation to views 19 in order to cause the display 101 to switch to a sub-type view based upon a known property. This achieves a more compact result that repeatedly using the preceding paragraph;

(c) Cursor compatible operation: This is referred to in the named view 183 to indicate the operations 99 which are applicable to the current cursor position;

(d) Recently mentioned instance: This special 248 is used for restricting a query;

(e) Type compatible role: This is automatically used when identifying a role 11 whilst adding a reference 44 to a piece of logic 2; and

(f) Unconstrained instance: This is used to cause constraints 211 to be considered.

Another kind of primitive definition 128 is the numeric primitive definition 249. These are well behaved two roled associations 21 which can operate in either direction. They are designed to correctly yield expected values and logic which uses these numeric concepts will yield the correct answers. Some examples of numeric primitive definitions are:

(a) any number which does equal or exceed any numbers

(b) any number does exceed any numbers

(c) any number does have as absolute a number

(d) any number does have as fractional part a number

(e) any number does have a integer part a number

(f) any number is exactly divided by a number

(g) a number does have as inverse a number—Reflexive

(h) a number does have as negative a number—Reflexive

(i) a number is square of any numbers

(j) a number is antilog of a base number and a log number

(k) a number is log 10 of a number

(l) a number is natural log of a number

(m) a number is cosine of any radians

(n) a number is sine of any radians

(o) a number is tangent of any radians

The next sort of primitive definition is the arithmetic primitive definition. These have one role which has the role attribute 24 known as “repeatable”. This attribute indicates that references 44 to these concepts 17 may be made with more than the expected number of reference roles 137. These are actually of little use unless the role is repeated at least once to make three reference roles 137. This is because the total of a single number is useless. This role may be repeated as often as necessary.

The arithmetic primitive definitions known as product 254 and total 255 are used to enable the invention to provide capabilities of spreadsheet which uses these concepts and is able to work in all expected directions with known roles 11 being used to determine the value of unknown roles 11. It is possible to operate arithmetic primitive definitions using the same logic as enumerations 43. It is also possible to mix references 44 to arithmetic 250 and enumerations 43 within the same definition 10. This rationality breaks down the traditional boundaries between databases and spread sheets. Some examples of arithmetic primitive definitions are:

(a) a number is total of any added numbers

(b) a number is product of any multiplicand numbers

(c) a number is least of any little numbers

(d) a number is greatest of any great numbers

The next kind of primitive definition is the approximate primitive definition 251. These provide the text matching and search capabilities of the present invention. Some examples include:

(a) any proper word does loosely spell any proper words

(b) any proper word does partially name any things

(c) any text does loosely contain any text

(d) any text does partially contain any words

(e) any instance does have as loose name any text

(f) any word does sound like any words.

The next kind of primitive definition is the cycling primitive definition 252. These definitions convert times from an absolute time to a time within a recurring cycle such as a week Some examples include:

(a) any absolute time does have as time of day a hour minute of day

(b) any absolute time does have as time of week a day hour minute of week

(c) any absolute time does have as time of year a month day of year

(d) any absolute time does have as time of leap year a month day of leap year.

The next kind of primitive definition is file systems 253. The concept net of file systems 253 is shown in FIG. 24. These primitive definitions make the file system of the underlying operating system accessible via the universal logic 2 and the logical external user interface 3. File systems serve as a example of how a whole “application area” may be operated in a standard and regular fashion by creating the appropriate types 20 and associations 21. In the past this has required programming of large numbers of humanly programmed screens.

While the following list of file system primitive definitions enables the system to work well, further primitives may be added in order to write a more comprehensive interface into an operating system. An extended set of primitives would allow the system to be regular and inherently documentable to a previously unheard of extent. Examples of file system primitive definitions 253 are:

(a) any file does have the file name

(b) any files does have as time the year, month, day, hour, minute

(c) any file does have any file attributes

(d) any directory does contain any files

(e) any plain file does have as length the count

(f) any plain file does have a file extension

(g) any drive does have as capacity the count

(h) any drive does have as used the count

(i) any drive does have as free the count

(j) any database does have the database type

(k) any database is described by text

(l) any database is spawned from a database

(m) any file extension is opened by a program

(n) any file extension is edited by a program

Logical External Intetface (3)

Returning to FIG. 12 it can be seen that the concept net 1 organises the storage of data in the information system and defines how each of the different pieces of information relate to one another. The logical external interface 3 presents the information to a user 14 and enables the program to communicate with printing devices and other external software. The following description provides details of the nature and internal workings of the logical external interface.

In a typical information system according to the invention, there are likely to be hundreds or even thousands of different types 20 which are arranged in elaborate hierarchies of sub-types which are related to one another by myriads of associations 21. Prior art information systems do not allow for the creation of new types and associations, because such systems normally require software developers to program a whole new interface in order to deal with such new kinds of information.

Because the present invention provides the facility for types and associations to be created the inventors have developed a highly automated and regular user interface which is able to present both data and the logic behind the data without having to redesign the interface every time a new type 20 or association 21 is created.

FIG. 5 shows a schematic diagram of the kind of display commonly found in prior art information systems. Such a display shows a mixture of data and operations on that data without showing the underlying logic used to retrieve the data or act on the operations. In contrast, the logical external interface 3 of the present invention uses a display 101 which not only shows the data stored in the information system but also the logic used to retrieve that data. The inventors have found that all data and logic can be expressed in terms of three phrases 126 which they have called reference phrases 146, connection phrases 147 and instance phrases 148. The reference 146 and connection phrases 147 show the controlling logic 2, whilst the instance phrases 148 show the retrieved data. In order to present this information to the user 14, the present invention uses a display 101 which includes a data display 125 and a logic display 152. The data display 125 presents data which has been retrieved in accordance with the controlling logic 2. The logic display 152 is provided in order to allow a user to enter and modify the logic 2 which controls the way in which the concept net 1 is organised and acted upon.

As shown in FIG. 25, the interface of the preferred embodiment includes a window 151 provided by the operating system. This window 151 can be as small or as large as required and may be at any screen resolution. The window may be moved or resized at any time with the contents being reformated to suit.

Within this window, the user is presented with displays 101 as required. Each display occupies the fill width of the window but is only as high as necessary. As new displays are presented, the prior displays are retained for reference for as long as there is room for them in the window. In the preferred embodiment, only the bottom display 101 is active. As the user finishes with one active display it is automatically removed, thus allowing more room for prior displays.

By providing a logical display which may be acted upon by the user action system 4 a user 14 is able to create new types 20 and associations 21, thus allowing the system to be readily adapted to new applications, without a user having to be a computer programmer. FIG. 6B shows an example data display 125 and FIG. 6A shows the corresponding logic display 152 which shows the logic behind the displayed data. FIG. 6B shows a data display 125 which includes a number of reference phrases 146, each having a corresponding connection phrase 147 and corresponding instance phrases 148. For those reference 146 and connection phrases 147 which do not have any corresponding instance phrases 148, a set of square brackets 153 appears. In this example, towards the bottom of FIG. 6B the reference phrase 146 “dinner”, the connection phrase 147 “day of week” and the instance phrases 148 “Monday . . . Sunday” indicate that the Brindabella Buffet Restaurant serves dinner on Monday, Tuesday, Wednesday, Thursday, Friday, Saturday and Sunday. Using the data display 125 a user 14 may amend the data provided in the instance phrases 148 if, for example, the restaurant no longer serves dinner on Mondays. If a user 14 wants to record the days of the week on which the restaurant is open for brunch, then they could do this using the logic display by creating a new association between restaurants and day of week which will be automatically referenced in the standard view of restaurants.

As shown in FIG. 6A, each display has a title area 154 which contains a presentation reason 155, the display type 156 and the name of the definition 10 whose logic 2 is controlling the particular display 101. The presentation reason 155 indicates why the particular display 101 is being presented. This reason is browsable so that the user has access to any special rules, conventions, protocols or general instructions which relate to thee current display 101. The display type 156 will either be a data display 125 or a logic display 152. Under the umbrella of the logic display 152 are two other displays known as the master logic display 157 and the copied logic display 158. The master logic display is protected by the security features 214. In contrast, the copied logic display 158 is discarded after it has been used and may be modified by any user. It therefore does not permanently affect the master logic.

The following discussion provides more details about the phrases 126 used in the display 101. As may have been understood from the above description of FIGS. 6B and 6A, every phrase 126 which is presented in the displays 101 represents a thing 8 (or occasionally a number 6) which exists within the system. The structure and the nature of that thing 8 is, of course, defined by its particular concept net 1. Because of the interconnected nature of things 8 in the concept net 1, every phrase 126 is shown in the display 101 is effectively a link to some more detailed information. In addition, meaningful operations 99 may be performed on every phrase 126. As mentioned earlier, only three kinds of phrase 126 are needed in order to present all data and logic to a user 14. In the preferred embodiment, whilst phrases 126 may occur repeatedly, they are always presented in the same sequence and every phrase type has a direct correspondence with one of the elements of the universal logic 2. The three phrase types are connection phrases 147, instance phrases 148 and reference phrases 146. Connection phrases 147 correspond to a connection of logic 159 (discussed above with reference to the universal logic 2). Connection phrases 147 are represented by the name of the particular type 20 whose members 26 are the data on the logical connection 159. When displayed, a connection phrase 147 is always followed by at least one instance phrase 148.

Instance phrases 148 are represented by the names of the instances 5 (discussed with reference to the universal logic 2). As shown in FIGS. 6A and 6B, where the instance phrase 148 does not have a value, it is indicated by a pair of square brackets. In a logic display 152, an instance phrase 148 corresponds to a value 161 on a connection 159. In a data display 125, an instance phrase 148 corresponds to the data retrieved in accordance with the logic 2.

Reference phrases 146 correspond to a reference 44 of logic 2. They are represented by the name of the appropriate role 11 of the definition 10 which is being referred to. Reference phrases 146 most commonly correspond to roles 11 of associations 21 such as “owned by”, “manage”, “has total price” and the like. A reference phrase 146 which corresponds to a concept 17 which has two roles 11 will be followed by one connection phrase 147. A reference phrase 146 corresponding to a concept 17 which has one role 11 will be followed by no connection phrases 147. A reference phrase 146 which corresponds to a concept 17 which has three roles 11 will be followed by two connection phrases 147.

The following discussion relates to the presentation aspects of the logical external interface 3 and describes the different ways in which phrases 126 can be presented to a user 14 or provided to an external device, depending upon the requirements. A particular presentation selected is either based upon the data which the user 14 selects to retrieve, or upon the user's preferences. The present invention provides a large number of presentation styles 75. These styles may be suitable for interactive use, for database reports, for formal memos, for overheads and the like. These styles 75 enable the present invention to replace normal word processor programs by presenting the information stored in the information system in a number of desired formats. In a similar way, the present invention can be used to replace existing spreadsheet programs. Further detail about presentations 163, styles 75, viewing definitions 144 and named viewing definitions appear below.

Referring firstly to presentations 163, the three different phrase types 126 are automatically presented by the system in a presentation 163 which is suitable to the characteristics of the retrieved data. Whilst this usually occurs automatically, some influence may be exercised by a selected style 75. The main kinds of presentation supported by the present invention are:

(a) Textual: FIG. 7A shows a textual presentation 164. This kind of presentation 164 is usually applied to data about a single subject and is shown using indented text The instance phrases 148 “Monday . . . Sunday” are shown in this tabbed format, which is both compact and clear. When displaying this information, the system presents the instance phrases 148 on as many lines required, with tabs between each piece of data.

(b) Tabular: A tabular presentation is shown in FIG. 7B. This kind of presentation is usually used when data is requested about a number of different subject instances. In this case rather than just showing information about a restaurant called “Cuddle & Bubble”, the tabular presentation also shows information about Belucci's and Belucci's South. In this presentation the headings in the left hand column correspond to the reference 146 and connection phrases 147 and the information in the remaining columns correspond to the instance phrases 148, which in this case are the details of the restaurants.

(c) Diagrammatic: FIG. 26 shows a diagrammatic presentation 166. This presentation is used when there is a high degree of interconnectivity between the data. As shown in FIG. 6, the data is presented in boxes 167 and the reference phrases 146 are illustrated by interconnecting lines 168. This diagrammatic presentation 166 also includes a legend 169 which identifies the correspondence between the line 168 shown and the association 21 which the reference phrase 146 refers to. In this case, the lines 168 represent the association known as “included in group”; and

(d) Plot: FIG. 27 shows a plot presentation 170. This kind of presentation is used to represent pairs of numeric quantities 47. In this example, the numeric quantities are degree latitude and degree longitude and is used to show the relative position of various towns. As with the diagrammatic presentation 166, the plot presentation 170 also includes lines 168 and a legend 169 which identifies the significance of the different line types. In this example, the straight thin line corresponds to the reference phrase 146 “connected by road” 171.

A number of logical definitions 127 control the way in which data is retrieved and presented. These logical definitions 127 include viewing definitions 144 and named viewing definitions 145. A number of viewing definition types are provided with the system, as follows:

(a) A Standard View: An example standard view 173 of some master logic is shown in FIG. 28A. The copied logic shown in FIG. 28B was automatically derived from the master logic shown in FIG. 28A. Both these displays have the type: type 20 as their subject. The (expand, exclude) reference 44 in FIG. 28A causes the copied display in FIG. 28B to inherit the properties of the supertype 176 of Type which is Concept. The standard view 173 of Concept causes a similar inheritance from it supertype 176 Definition and hence to its supertype 176 which is thing 8. All but the last group of references 44 in FIG. 28B have been inherited from the direct or indirect supertypes 176. This inheritance greatly simplifies the user interface. The lower (expand) member reference of FIG. 28A will cause a similar downward expansion of properties once the type class is known. This downward expansion can continue as the triggering values are entered by the user. This provides for an automatic form layout based upon increasing content It also provides most of the functionality of the popular “wizards” of prior art inventions;

(b) A Cross Reference View: FIG. 29 shows an example of a cross reference view 174. The cross reference view is the viewing definition 144 which shows where something is used. This view usually contains references 44 to associations 21 which are either unlikely to be of common interest to most users 14, or would yield too many values 161. When a new association is created, a reference 44 to it is usually placed in the standard views 173 of both involved types 20. This automatic insertion of references can be controlled by the role attributors 24 not to standard and not to cross reference. The (expand, exclude) reference 44 of FIG. 29 is there to cause inheritance of references 44 from the cross reference views of the supertypes 176 of the subject type, in this case definition. This was explained in (a) and is the same for all viewing definitions 144. All the (expand) references 44 are there to switch down to the cross reference view of subtypes 178. The ones following “also” references 44 will switch to a particular view if it is appropriate while the (expand) member ones can select a particular subordinate view depending upon the value given;

(c) A Schema View: FIG. 30 shows an example of a schema view 175. This is a viewing definition 144 which shows all of the direct sub-types by a particular type 20 and all of the associations 21 which it is involved in. This view is usually used to confirm the relationships between data rather than to control the display and retrieval of data. Such schema views 175 are automatically updated whenever new types 20 and associations 21 are created. This view in FIG. 30 shows the super type 176, its direct properties 177 and its sub-types 178.

(d) A Recursive View: FIG. 31 shows an example of a recursive view 179. This view is a viewing definition 144 which refers to itself in order to traverse a tree structure. These views are automatically created whenever they are appropriate. Numeral 180 in FIG. 31 shows Terran cuisine includes eastern and western cuisines, eastern includes chinese and indian, chinese includes cantonese and schezwan. The recursive view of terran cuisine would show all directly and indirectly included cuisines while the recursive view of chines would shown only: chinese, cantonese and schezwan;

(e) A Naming View: FIG. 32 shows an example of a naming view 181. This view is a viewing definition 144 which automatically forms the fill names of the members 26 of its subject type 20. For example a full street address might be formed from the street number, the street name, the suburb, the abbreviation of the state or territory and the post code of the suburb; and

(f) A Porting View: FIG. 33 shows an example of a porting view 182. This view is a viewing definition 144 which specifies the data which should be included when a member 26 of a particular type 20 is exported or imported. They are automatically updated under the control of the role attribute 24 known as “not to porting”.

The following discussion provides details about named viewing definitions 145. Named viewing definitions exist to control the presentation of the displays 101 but, unlike viewing definitions 144, they are unique to particular types 20 and do not necessarily exist for all types. Accordingly, they each have unique names rather than names which are appropriate to a set. Named viewing definitions 145 are organised into the following sets:

(a) A Named View: FIG. 34 shows an example of a named view 183. This is a kind of named viewing definition 145 which is logical. The logic controls the data display 125 and the informal exporting or importing of data. The example shown in FIG. 34 shows a named view 183 known as a performance view 184. This view is only relevant to the types 20 known as “users” 14. Named views 183 may contain conditions which restrict the data displayed only some of the members 26 of the type 20 concerned. This view may also include information which specifies the sorts of data which should be retrieved about subject in question;

(b) A Tour: FIG. 35 shows a tour 185. The named viewing definition 145 represents a sequence of data displays 125. The tour 185 is similar to the named view 183 but also contains a special reference 44 to “operated on by the operation”. The browse operation 186 (discussed in detail with reference to the user action system 4) is the usual operation 99 that operates on the type 20 in question. However, other operations which present data may also be involved. The operation 99 itself does not need to be a constant but could be determined by the logic 2 contained within the tour 185. In the example of FIG. 35 operation will 187 is a primitive command which will operate the browse operation 186 on every application in turn, and will present a separate display 101 for each;

(c) A Context View: FIG. 36 shows an example context view 188. This is a kind of named viewing definition 145 which does not have any roles 11. It presents a data display 125 about a number of instances 5 which are not related to one another, but which may be of interest to a user 14. The instances in example of FIG. 36 include the current tine, the current data base and the current directory;

(d) An Indirect Text View: FIG. 37 shows an example of an indirect text view 189. This view is a kind of named viewing definition which is used to retrieve data which is presented as a formal reference 13. Indirect text views are invoked by formal references 13 within text 12. The example in FIG. 37 steps from the paragraph to a warning that the paragraph is a “summary of”. It then steps to the instance that is the “first subject of the warning”. The name of this instance then appears as the text of the formal reference 13. Indirect text views can be used to alter the text of the letter depending upon the person it is being sent to. It can also be used to make a warning message have specific context; and

(e) A Simulation: FIGS. 41A through 41E show examples of a simulation 190. Simulations are named viewing definitions 145 that do not have roles 11 and which implement a set of inter-related equations. Simulations also allow unknown variables to be calculated on other information that is known. FIG. 41 shows the master lodging of a simulation known as “cylindrical tanks”. This master logic has two references 44 to product/multiplicand, each having three roles. The copied logic shown in FIG. 41B with the hidden values results in the data display shown in FIG. 41C. In this example, when given the diameter length of 4 metres and the height length of 2 metres, the area and volume can be determined. As shown in FIG. 41B the content mass and the content density are still unknown. As shown in FIG. 41D when the content density is supplied the resulting part of the display shown in 41E determines actual values for the content volume and the content mass. In this way a simulation 190 allows unknown variables to be calculated from whatever values are known.

The following discussion provides details of the different styles 75 used in the logical external interface 3 of the present invention. A style 75 is a thing 8 which controls the presentational aspects of the displays 101 but which does not have any effect on the content of the information displayed. Whilst using this information system a user 14 may enter, update and query all different kinds of information. In order to allow the user to readily comprehend this information it may be appropriate to insert column headings and field identifiers around that data. However, in another context, if the user was willing to produce a formal letter, then column headings and field identifiers would be inappropriate and such a letter would involve a much more sparse format. In contrast to systems of the prior art these presentation changes are implemented using styles 75. Letters, memos and the interface used to present user information on screen are presented in different ways according to their individual styles 75.

FIG. 42 shows the styles concept net. As shown in that Figure a user 14 will have a default style 75 for the usual interaction with the system, and for printing. A definition 10 may specify 191 a style 75 for use on its resulting data display 125, and in this way overrides the user's default. In addition, an operation 99 may specify 191 particular style 75 which overrides any previous defaults.

Also shown in FIG. 42, a device 192 is a thing 8 which is provided by the operating system and which is used for presenting information. Examples of devices 192 are printers, screens, fax sending devices and the like. A device may be the default 193 printer device for a user. A device 192 may also be specified by 194 and operation 99. A device 192 may support 195 one or more device capabilities 196. These device capabilities 196 include features such as bold, italics, colour, font, font size, line drawing, area patterns, area fills and the like. Also shown in FIG. 42, a display component 197 is a thing 8 that can be used to refer to different parts of a display 101. A display component 197 may be an area component 198, an element component 199 or a connection component 131. An area component 198 refers to a particular area of a display 101 such as the title area 154. These components cannot be created by end users 14. Element components 199 identify particular features of a display which could not be described as an area. These features include the cursor, or the border of a table. Once again these components cannot be created by users 14. Connection components 131 establish a convention which should be applied to specific connections 131 of the universal logic 2.

Also shown in FIG. 42 is a style tip 201. Style tips are things 8 which are held in 132 styles 75 and which specify the stylistic options which should be applied to those display components 197 which the style tip 201 effects 202. Only certain style tips 201 are used. Those style tips are the ones whose required 203 device capability 196 is supported by 204 the current device 192. A particular style 175 may hold 133 (or contain) any number of style tips 201. Any number of display components 197 may be affected by 205 the one particular style 75. The concept then also shows that many style tips 201 may be provided for the same display component 197 in order to cater for different devices 192 which have different device capabilities 196.

Although not shown in FIG. 42, a style tip 201 may have any number of style tip attributes 206 and properties. These attributes and properties, in the preferred embodiment, cannot be extended by users 14. Sufficient numbers of style tips are provided in order to enable most commonly used formats to be produced, such as letters, memos, faxes, different kinds of tables, diagrams, plots and the like. As additional formats become necessary, additional attributes and properties may be added by the system programmers without need to reprogram other parts of the system.

Some of the more important style tip attributes 206 and properties are:

(a) Single Full Page: This format uses one full page and is appropriate for letter formats;

(b) Displays Share a Page: This enables multiple displays to be printed on the one printer page;

(c) Font Size As Level Indicator: This attribute is used to display major and minor paragraphs;

(d) Space As Level Indicator This attribute provides additional space around major paragraphs;

(e) Omit Jump Keys In Active Display: This attribute presents a visually appealing page but provides for slower user interaction. Jump keys are a key stroke, which appears on the screen in front of a display phrase. The pressing of the key stroke will immediately move the cursor to the said display phrase;

(f) Omit Component;

(g) No Alignment Of Instances: This attribute does not align instances vertically;

(h) Don't Use Tables;

(i) Use Diagrams;

(j) Use Legending: This attribute is used in order to save columns;

(k) Has Font;

(l) Has Font Size In Points; and

(m) Has Verbosity: This attribute is used to implement verbosities such as suppressed, terse and verbose.

User Action System (4)

Referring to FIG. 12, the user action system 4 allows a user to interact with a logical external interface by means of a series of operations 99. Using the user action system 4, the user 14 can not only retrieve data but can also add new members 26 to existing types 20 and create new types and associations. In this way the user is able to expand the concept net 1.

The user action system 4 enables the user 14 to move the cursor, edit text or perform operations 99. The cursor may be placed on every phrase 126 in every display 101 and as it does so relevant operations 99 become available to the user. One of the more commonly used operations is browse 186. As the user proceeds through the various user levels 102 they are provided with access to additional operations 99. A standard set of operations 99 is provided with the system, but additional operations may be created by the user in order to automate just about any repetitive task required. The user action system 4 has a number of features which will be discussed in detail below. These features include operations 99, standard operations 207, rejection reasons 208, warnings 209, presentation reasons 155, commands 18, defaults 193, constraints 211, logical enumerations 212, identification definition types 213 and security features 214. The following discussion provides details of each of these elements in turn.

Dealing firstly with operations 99, these are things 8 which facilitate all user interaction except for cursor movements and text editing commands. When called, an operation 0.99 will usually effect the instance 5 which the cursor is positioned over. If a particular operation applies in a more general sense, then this default action may be overridden by the association 21 known as “an operation may have as subject a thing”. In order to use that particular operation 99, the user can press a particular key on a keyboard or click a relevant place with a mouse. The various key strokes and mouse actions may be configured by a user 14. In one embodiment, the available operations for a particular instance 5 represented as a list and the operations are chosen by selecting one of the items on the list or by entering the operation's name. The function performed by a particular operation 99 depends upon its operator action 215. Some of the more commonly used operator actions appear below:

(a) Data From: This operation action causes the system to present a data display 125 which shows information about the subject or instance 5 concerned. The particular view 19 displayed will usually be the standard view 173, but may be influenced by the controlling definition 216;

(b) Logic Of: This operator action causes the system to present a copy logic display 158 which provides data about the particular subject or instance of interest. Once again, the view 19 presented will normally be the standard view 173, but may be influenced by the controlling definition 216;

(c) Master Logic Of When an operation 19 having this operation action 215 is invoked, the system presents a master logic display 157 about its subject. Once again this will normally be the standard view 173, but may also be influenced by the controlling definition 216;

(d) Use: This operator action causes the logic 2 of the controlling definition (which is usually a command 18) to operate without presenting any display 101 to the user 14;

(e) Select From: When an operation 99 which has this operator action 215 is invoked by providing the operation with a subject 217 which is not a controlling definition 216, then the result of such an operation is that the subject 217 is inserted at the cursor position. This feature enables the system to provide very fast one key identification. However, if a subject 217 is not provided when the operation 99 is invoked then the user 14 is presented with a list of candidates, which they can select from. If there is a corresponding controlling definition 216 involved, then its logic 2 will determine which candidates are presented in the list Alternatively, all members 26 of the particular type 20 will be displayed as candidates; and

(f) Type Thru: When such an operation 99 is involved, the controlling definition 216 is used as a template. Comma separated data may be typed through this template in order to create a new thing 8. This feature allows the user to enter data very quickly.

Operations 99 may be controlled by definitions 10. Many of the standard operations 207 provided with the system are controlled by definitions which are primitive commands 218. An example of a primitive command is “identified by typing”. In order to produce more complex behaviour, operations 99 may be controlled by logical commands 219. Such logical commands often refer to primitive commands 218. Furthermore, in order to present particular views about the instance 5 which the cursor is positioned on, an operation 99 may be controlled by viewing definitions 144 of named viewing definitions 145. Furthermore, some operations 99 are not controlled by any definitions 10.

Operation attributes 220 affect the behaviour of operations 99. A number of the more common operation attributes are described below:

(a) Tailored: When an operation with this operation attribute is invoked, the controlling definition 216 is presented in a copy logic display 158 so that the user 14 may edit the logic before the operation is performed;

(b) Stay: When a list of operations 99 is presented to a user 14 and the user selects one of those operations, then that list will normally disappear before the operation is performed. However, if that operation has an operation attribute of “stay” then this will cause the list of operations to remain for subsequent selections;

(c) As Reference: Logical definitions 127 can be used directly, but controlling definitions 216 cannot. In order to use a controlling definition a user 14 can invoke an operation 99 which has the operation attribute 220 of “as reference” and this way uses the controlling definition 216 by making reference to it, rather than using it directly. Although logical definitions 127 can be used directly, they may also be used by reference;

(d) Non Cursor: An operation with this operation attribute will not act upon the instance 5 which appears under the cursor. This attribute is mainly used to allow operations 99 to begin a completely new thread of work that is unrelated to the display 101 which is currently presented to the user;

(e) Direct: When the subject 217 of an operation 99 is being determined by the system, it usually acts on the instance 5 which appears under the cursor. However, some operations have a different instance as their default subject, such as other information that may be of relevance to the user. By using an operation 99 which has the operation attribute known as “direct” the operation is forced to used the instance 5 under the cursor as the subject 217;

(f) Inline: If a data display 125 contains an operation 99 which has the operation attribute 220 of “inline” then the results of that operation 99 will either be included within the original data display 125, or will result if the user browses to the inline operation. The results of the operation will be automatically included within the data display if the style 25 in force has the attribute of “report in line” and if the corresponding connection 131 includes a reference 44 to the definition 10 known as “report in line”. When a user browses to an inline operation (or a formal reference to one), the results of the operation are displayed not usual properties of the operation. When the “report in line” reference is present, the inline operation will be executed without the requirement to browse and any resulting display from the operation will be blended into the existing display which holds inline operation;

(g) Auto Select All: When an operation 99 has this attribute and also has the operator action 215 of “select from”, then it causes all of the candidates presented in the selection list to be automatically selected;

(h) Auto Select None: Similarly, when this attribute is set in an operation 99 which has the operator action 215 of “select from” then when it is invoked, the operation prevents the normal automatic selection occurring when there is only one candidate; and

(i) Priority: This attribute allows a specific operation 99 to be used in preference to a general one. When a number of operations 99 are available using the same key 221 and one of them has the operation attribute 220 of “priority” then that operation will hide and override the other operations involved. Usually, an operation 99 which has the operation attribute 220 of “priority” will be controlled by a definition 10 whose corresponding type 20 is more restricted than the non-priority operations.

Operations 99 may have a corresponding style 75 which overrides the default style 104 of the user 14. Such an operation may specify that a particular device 192, such as a printer be used instead of displaying the information on a screen.

The present invention provides a number of standard operations 207 which are sufficiently general and powerful to enable just about any kind of application to be created within the invention. However, the system is sufficiently flexible to allow additional, more specialised operations 99 to be created whenever needed. The standard operations provided with the system include identification operations 222, creation operations 223, presenting operations 224, operations causing logic interpretation 225 and general operations 226. The following paragraphs describe each of these standard operations in turn.

Identification operations 222 are used to enter data at the cursor position is just about all applications. Such operations identify a particular instance 5 which should be inserted at the position of the cursor. The most commonly used identification operations are:

(a) Type For: This is used to identify a thing 8 by entering in part of its given name 119;

(b) Edit For: This operation is used to identify some thing 8 by editing a copy of the name under the cursor;

(c) Select From: This operation is used to provide a selectable list;

(d) Tailored Select From Standard View: This operation is used to choose the results of a query; and

(e) Delete: This operation is used to reverse a previous identification operation 222.

Presenting operations 224 usually act upon the instance 5 which appears under the cursor and results in a display 101 being presented which amplifies that instance 5. A set of presenting operations 224 is infinitely extensible, but a limited set has been provided with the system. Certain presenting operations 224 are compatible with certain instances 5 and incompatible with others. When the cursor is positioned above a particular instance, only those compatible presenting operations 224 will be available for the user to select. Some of the more common presenting operations are:

(a) Browse To: The browse to 186 operation when invoked acts upon the instance 5 which appears under the cursor and displays a data display 125 which corresponds to that instance 5. The browse to operation normally defaults to a standard view 173 when presenting this information. If, however, the system detects that an alternative instance 5 would be of greater interest to the average user 14, then the data display 125 on that instance 5 would be presented instead;

(b) Browse Directly: When this operation is invoked, it acts upon the instance 5 directly under the cursor and presents a data display 125 corresponding to that instance 5 in standard view 173 format;

(c) Cross Reference View: When invoked, this operation presents a data display showing where the instance 5 appearing under the cursor is referred to or used;

(d) Logic Of Standard View: When this operation is invoked, the system presents a copied logic display 158; It is based upon the instance 5 under the cursor. This operation is often used as the staring point of an ad hoc query; and

(e) Master Logic: This presenting operation 224 allows the user to edit a definition 10 by presenting the logic 2 of that definition.

The next kind of standard operation 207 are the operations causing logic interpretation 225. These operations include “present data” and “force data”. The present data operation available for use in the copied logic display or the master logic display 157. This operation causes the logic 2 to be interpreted and presents the result in data display 125 to the user 14. When invoked, this operation causes any references 44 which have the reference attribute 140 of “WILL” are interpreted merely as “COULD”. The operation also rejects any values that are currently associated and any which violate any constraints 11. The force data operation may also be used from anywhere in the copied logic display 158 or the master logic display 157. This operation causes the logic 2 to be interpreted and presents the resulting data display 125. When invoked, this operation causes all references 44 with a reference attribute 140 of “WILL” will cause the expected insertions or deletions.

The next kind of standard operation 207 are general operations 226. These allow the general control of the displays 101 and include the following.

(a) Exit From Display: When this operation is invoked, the current display 101 is removed and anything created within it is accepted and stored in the system;

(b) Abort From Display: When this operation is invoked, the current display 101 is removed and any information created or changed within that display is abandoned;

(c) Hold: This operation causes the particular display 101 to remain visible on the screen if possible; and

(d) Print Display: Apart from opetations 99 and standard operations 207, the user action system 4 also includes rejection reasons 208. These reasons things 8 which are presented to explain why an operation 99 cannot be applied to the instance 5 which appears under the cursor.

Apart from operations 99 and standard operations 207, the user action system 4 also includes rejection reasons 208. These reasons things 8 which are presented to explain why an operation 99 cannot be applied to the instance 5 which appears under the cursor.

The user action system 4 also includes warnings 209. Warnings are things 8 that are presented to explain why an operation 99 that has been allowed to start, cannot be successfully completed. Such warnings usually result from typed text which does not comply with certain rules.

The user action system 4 also includes presentation reasons 155. The presentation reasons are things 8 which indicate why a particular display 101 has been presented. These reasons are often the direct and obvious result of the last operation 99, but may also result from an obscure consequence and make it clear to the user why the particular information is presented on the screen in the way that it is. Users 14 are able to browse to 186 presentation reasons 155 in order to locate any specific rules or conventions which apply to the display 101 and to identify the main options which are available to the user 14.

One of the other features of the user action system 2 are commands 18. Commands are a kind of definition 10 which defines a method of changing information held in the system, or changing displays 101. Commands 18 may be broken down into primitive commands 218 and logical commands 219. A number of primitive commands are provided with the system. The more important primitive commands are implicitly described under the operations 99 which they control. Logical commands may be built as required by the user. Each local command should have a reference 44 which has a reference attribute 140 of “WILL”. This attribute indicates the association 21 which will be modified when the command is invoked. Logical commands 219 function by finding values for any connections 131 which are adjacent to the reference 44 which has the “WILL” attribute. Once these values are located, then the logical command inserts or deletes relative pairs as appropriate. FIG. 39 provides an example of a logical command 219. In the example, the logical command depends upon the entry point 100 of the current user 14. Defaults 193 are an additional feature of the user action system 2. When a new member 26 of a particular type 20 is created, the default 193 is used to set default values for the parts of that newly created member. As such, a default is a definition 10 that is logical. Most of the references 44 in a default 193 will have the qualifier “WILL”. FIG. 38 shows a sample logic of a default 193. In that example, the default for the type 20 shown as “message” is shown. When a new message is created, it is created on “some date”. The default illustrated here specifies that when a new message is created, the current date is inserted. Similarly, the message is written by “some body”. The default for this is the current user 14. As such, the default 193 for a new message inserts the current date and current user into the user.

Another feature of the user action system 2 is its constraints 211. Constraints define conditions which must not be allowed to incur. Constraints are implemented as definitions 10 which do not have a role 11 and which are logical. FIG. 43A shows the sample logic of a constraint 211. The constraint shown ensures that a user 14 never studies a user topic that depends on another user topic that is not known by the user. In order to enforce such constraints, the user action system 2 uses insertion checks 227 and deletion checks 228. Sample logic of an insertion 227 is shown in FIG. 43B. This Figure shows the constraint of FIG. 43A transformed into an insertion check 227 which has two roles 11. This insertion check will be checked whenever a user 14 attempts to insert the user topic that a user is studying.

Insertion checks are created from constraints 211 which have references 44 without the reference attribute 140 of “not”. Deletion checks are created from constraints which have references 44 with reference attributes 140 of “not”. These checks 227, 228 have the same number of roles 11 as the concept 17 which is referred to by the reference 44 from which they were transformed. In this way, insertion checks 227 and deletion checks 228 guard the reference 44 they were transformed from.

An insertion check list 229 provides a list of related insertion checks 227. This list allows rapid access to all of the logic that needs to be checked before an association 21 can be added to. This list also makes it easier for humans to become aware of the information they need to provide in order to create a new association. Deletion check lists 230 are analogous to insertion check lists 229. When looking at the logic of the insertion check 227 it can be seen that it has the same network of references 44 as the original constraint 211 that it was derived from. The only exception is that the guarded reference is replaced by the alternative roles 135 of the new insertion check 227. The same applies to deletion checks 228.

The user action system 2 also indudes logical enumerations 212. Logical enumerations 212 are concepts 17 which have a logical implementation 231 and an enumerated implementation 232. Enumerations 212 provide means for accessing data quickly. They do this by storing the information in a redundant fashion whilst the logic defines how the enumeration 43 should be kept current. FIG. 44A shows a logical enumeration that ensures that a user will automatically be given any style which is selected by the user topic which the user is studying. Logic is transformed into two effects 202 shown in FIGS. 44B and 44C respectively. The first effect is automatically accessed whenever a user studies a new topic. If that user topic selects a particular style 75, then that style then qualifies the user 14. The second effect shown in FIG. 44C is automatically accessed whenever a user topic selects a new style. If the user topic is currently studied by a user then that user will then have that style 75. Now shown in FIG. 44D all of the possible effects 202 of inserting or deleting in a particular association are summarised in that association's corresponding effects list 234. As such, logical enumerations 212 result in effects 223 in a similar way that constraints 211 transform into insertion checks 227 and deletion checks 228. However, unlike the transforming of constraints 211, there is no need to distinguish between insertion and deletion effects, since these are handled by the propagation of insertion or deletion through the interpretation.

In addition, naming views 181 are also transformed into naming effects 235. These naming effects 235 are also referenced by the effects list 234 mentioned above. FIG. 45A shows some sample logic of a naming view 181. The information shown there defines the full name of a session to be made up of its conducting user, followed by its start date and time. This naming view 181 is transformed into the two naming effects 235 shown in FIGS. 45B and 45C respectively. Each of those naming effects 235 can trigger a reinterpretation of the naming view 181 when data changes. As shown in FIG. 45D, the naming effects 235 are referenced by the same effects list 234 as other logical enumerations 212.

Another feature of the user action system 2 is the feature known as identification definition types 213. These definition types are used at various stages when entering or identifying data. Identification definition types 213 include recents 236, recognisers 237 and entry views 238. A recents 236 (list) is a kind of definition 10 that defines the candidates from which selections are made. FIG. 40 shows the sample logic of the recents 236 shown as “phone”. This controls the list of phones which are presented to a user when choosing a recent phone. The logic behind recents lists are automatically created by the system but may be edited by those users 14 who achieve the user level 102 known as “developer”. Some types 20 have too many members 26 to be reasonably shown in a display 101. When recents 236 are applied to such types only those members which have been “recently mentioned” by the user 14 will be shown on the screen. Other types 20 which have the type attribute 41 of “closed” tend to have a limited number of members and, when a recent 236 is applied to such a type, all members of that type may be displayed. This is effected by the association 21 known as “any user does mention some types”. This association is nested upon by the type 20 known as “recent lists”. The additional association 21 known as “a recent list does contain any instances” actually holds the values concerned. These values are covered by the role attribute 24 known as “reverse ordered by insertion”. In this way, the relevant types which have been recently mentioned by a user are presented in a list which has the most recently mentioned type at the top.

In the preferred embodiment, the recents 236 list is not automatically pruned but users 14 have the option of pruning the list when they want to. Types 20 and associations 21 are automatically inserted into the recents 236 list whenever the user accesses such types and associations. New values may also be added to the recents 236 list by opening the operation known as “including in recents”. In addition, values may be added to the recents 236 list when the values are deleted from any association 21.

In order to present properties to assist a user in using the most relevant value in a recents 236 list, references may be added to the logic behind the recents 236.

Furthermore, other references 44 are automatically added to any definition 10 which is used for identification. These are added to a copy of the logic as required. In order to ensure that a value is compatible with its destination and constraints 211 a reference 44 to the primitive concept 239 known as “unconstrained” may be used.

When identifying an operation 99 with a view to evoking it, a similar reference 44 to the primitive concept 239 known as “cursor compatible” is inserted. When identifying a role 11 with a view to appending a reference 44 to it, a similar reference 44 to the primitive concept 239 of “role compatible” is inserted.

Recognisers 237 are definitions 10 which are provided by every type 20 in order to translate from the text that is currently being typed into a member 26 of the type 20 of interest. Recognisers 237 are automatically created by the system and rarely need to be modified. They usually contain a reference 44 to an approximate primitive concept 240 that will yield a few of the most likely matches.

An entry view 238 is a kind of definition 44 that is intended for data entry. Entry views 238 show all of the properties of the standard view 173 for all values which are returned by the recents 236 list. As new things 8 are created, entry views automatically build up in the recents list 237, showing all of their common properties. This feature enables a user to easily review the things 8 that have been recently created and entered. The user 14 is able to prune entries if they so desire.

Programming Considerations

When implementing the present invention in software, a number of programming considerations should be taken into account. Properties covered in this discussion win include implementations of the ordered stores 244, the concept net 1, the universal logic 2, the data 125 and logic 152 displays, the logical external interface 3 (or presentation system) and networking the invention with other programs and devices.

Dealing firstly with ordered stores 244. In the preferred embodiment the ordered stores 244 store information in a binary manner. Most enumerations 43 are binary in nature, such as person A owns dog B and should therefore be stored as binary storage. Because the ordered stores 244 provide access in only one direction, an association 21 will be represented by two ordered stores, one store for each role 11. An important feature of the ordered store 244 is that when one value is known, all values which depend from that value are yielded in a strictly increasing order. As shown in FIG. 46 the method used to access information in the ordered stores performs the steps of “test this or find next”. When implementing this access method, the logic interpreter 256 proceeds from connection 131 to connection, finding an acceptable value for each connection. The values which are found early will constrain possible values of later connections 131 if they are interconnected by a reference 44. For a value to be acceptable on a connection 131, it must satisfy all references 44 which are connected to it and whose other roles 11 do have known values. These references 44 are tested in turn until all of them agree on a value. By implementing a convention that the ordered store 244 must generate values in strictly increasing order, this enables a disagreeing reference 44 to suggest its next greatest value for testing by the next reference 44.

This is embodied in the function “test this” and “find next” as shown in FIG. 46. At the top of FIG. 46 is a connection 131 which has the type 20 known as “person”. That connection 131 has three references 44 connected to it. These are “resident of”, “occupation” and “hobby”. This represents a search for a person who is a resident of Victoria, whose occupation is a plumber and whose hobby is a train modeller. The testing sequence shown in the second half of FIG. 46 illustrates the value of the convention that ordered stores 244 generate values in strictly increasing order. As seen in the first line, the first Victorian which is tested has a unique internal identifier 37 of 17. On the second line the system tests person number 17 and detects that he/she is not a plumber. The system then looks through the ordered store to identify the next plumber whose internal identifier happens to be No. 1346. Because the value in the ordered stores 244 are generated in strictly increasing order, the system knows that between identifiers 17 and 1346 there are no Victorians who are also plumbers. The identifiers 37 between 17 and 1346 may therefore be skipped without concern that a Victorian plumber has been overlooked.

In line three, person No. 1346 is tested and found not to be train modeller so the next train modellet is identified as No. 1542. In line 4 person No. 1542 is found to be Victorian so they are therefore Victorian and a train modeler. On line five, person No. 1542 is found not to be a plumber, so the next plumber, No. 2866 is searched. Because ordered stores 244 generate values in strictly increasing order the system knows that between person No. 1542 and person No. 2866 there are no persons who are Victorian and train modellers. In line six, person No. 2866 is found not to be a train modeller, so the next train modeller is identified as No. 17123. In line seven person No. 17123 is found to be a Victorian. In line eight person No. 17123 is also found to be a plumber. As such, for person No. 17123 all references 44 which are joined to his connection 131 have been satisfied and person No. 17123 is therefore accepted. He satisfies all three references 44. The searching process then continues in line nine when the next person is detected, person No. 17124. That person is found not to be a Victorian, so the next Victorian is detected as person No. 17127. In line 10 that person is found not to be a plumber, so the next plumber is identified. This is person No. 17500. This searching process continues until all Victorian plumber train modellers are found.

Because of the way in which the ordered stores are set up, instead of having to look through all 3 million residents of Victoria, as shown at the bottom of FIG. 46, the maximum number of candidates which the system needs to examine is the number of connected references multiplied by the minimum number of candidates in any reference. In this case, there were three references and the minimum number of candidates was the two hundred train modellers. In this way, the system only needs to search six hundred of the ordered stores, rather than 3 million of them. By coding the ordered stores using this convention, extremely fast searching capabilities are achieved.

Turning now to the programming considerations involved in implementing the initial concept net; the concept net 1 should implemented in a number of stages. Each of these stages should individually work to create types 20, associations 21 and then members 26 of those types 20. In the preferred embodiment these stages are implemented by a large sequence of procedure calls each of which create a type, an association or a member of a type. These calls should be carefully sequenced in order to avoid references to members 26 which do not yet exist. The whole sequence of calls is operated repeatedly in a number of phases, each of which implement some aspect of the creating process.

Some of the aspects which need to be generated early in the piece are the ordered stores 244 needed to store the associations 21. Other aspects which can be created later concern the rules and conventions needed to be enforced on users 14.

The next programming consideration relates to the logic interpreter 256. This works by finding an instance 5 for every connection 131 so that all references 44 which joined to that connection 131 are satisfied. FIG. 46 illustrates this aspect.

For a two Roled Association 21 the Logic should perform in the following modes:

(a) Test This and Find Next on Role 1 given a fixed value on Role 2,

(b) Test This and Find Next on Role 2 given a fixed value on Role 1,

(c) Can the Logic be satisfied by the fixed values on both Roles.

If the Connections 131 can be visited in a sequence that is known to efficiently yield values on the unknown Role 11 that are non-redundant and correctly ordered then this sequence will be used. Alternatively the best possible sequence is used but the values that it yields must be held in a temporary Ordered Store 244 to ensure order and non-reduncancy. It is alway possible to get non-redundant ordered values by visiting the unknown Role 11 early but unless its Type 20 is known to have few Members 26 this strategy may be unacceptably inefficient.

The order is based upon such considerations as:

(a) Connections 131 with fixed values should be visited first,

(b) Only visit a Connection 131 if it is connected to a Reference 44 that has known values on all other Connections 131,

(c) Visit Connections 131 whose active Reference must yield exactly one value,

(d) Visit Connections 131 whose active Reference 44 might yield a value,

(e) Only then Visit Connections 131 whose active Reference 44 might yield multiple values,

The following paragraphs detail the programming consideration involved in implementing the data 125 and logic 152 displays.

Dealing firstly with the logic display 152, this display is presented in a straight forward manner exactly as specified by the Logic 2. There is a Reference Phrase 146 for each Reference 44 and a Connection Phrase 147 for each Connection 131. If there is more than one Alternative 129 then these are shown.

The text that is shown for each Reference Phrase 146 is derived from the Role 11 or Definition Names and Sentence Nature of the definition 10 being referenced, qualified by some representation of any Reference Attributes 140.

The text that is shown for each Connection Phrase 147 is the name of the Type 20 that is Involved In the Connection 131, qualified by some representation of any Connection Attributes 242.

The text that is shown for an Instance Phrase 148 is the name of the Instance 5 which is the fixed Value 161 on the Connection 131. If there is no Instance 5 then that is indicated by symbol [ ]. The symbol [ ] may contain system generated text to indicates certain conditions e.g. [Indeterminate]. In a Logic Display 124 only one Instance 5 can exist on a Connection 131.

A Style 75 may specify some Name Priority Roles in preference order which can select abbreviations or names in other languages.

Where the Logic 2 forms loops rather than simple trees, it is necessary to indicate that two Connection Phrases 147 actually represent the same Connection 131. In the usual Textual Presentation 164, this is done with matching <a > or <b> etc. The Instance 5 and further connecting References 44 are shown only on one of these Connection Phrases 147. The Diagram Presentation 166 is particularly suitable for showing joined Logic.

Turning now to data displays 125, these displays are presented in accordance with some controlling Logic 2. This Logic may come from many separate Viewing Definitions 144. The Reference 146 and Connection Phrases 147 in the Data Display 125 all correspond to References 44 and Connections 131 in the Logic 2.

A Connection Phrase in a Data Display may be followed by many Instance Phrases 148, for example when Fred owns Fido, Rover and Spot.

The order of presentation does not follow the order of References in the Logic but rather the path taken by the interpretation of the Logic. Fixed values will therefore appear first. The interpretation path does however follow the order of the controlling Logic when possible so that the user has control of the order of Columns and the like.

Viewing Definitions 144 may directly and indirectly refer to corresponding Viewing Definitions provided by Subtypes 178 of the subject 217. This allows a Data Display 125 to begin showing properties of a Thing 8 then switch down to properties of a Body, then of a Person, then of a Lawyer.

As Data may be directly inserted in and deleted from a Data Display by users it is necessary for the Data Display to be incremently maintained to include the changes to its content. This may bring new properties into view as other properties are changed. In the preferred embodiment there are no “grayed out” properties that are currently not appropriate. Turning now to the programming considerations involved in the logical external interface 3; this presentation system should be capable of presenting a Logic Display 152 of any complexity and a Data Display 125 of any complexity and volume; into a window of any size ot to any supported device. The devices may have widely different capabilities but these must be coped with automatically as there are potentially infinite numbers of possible displays.

As well as presenting information for human use, the presentation system mediates the exchange of data to files, printers and external systems. This involves various data exchange formats such as: XML, HTML, DIF, LDIF, CSV as well as the native porting format and a wide variety of other formats.

Interactive human presentations should be provided for the native operating system Graphical User Interface as well as HTML based browsers. Both of these should be able to support, in a transparent manner, the Looks And Feels that are specified by the various Styles 75.

In the preferred embodiment, the inputs to the presentation system take the form of a network (generally a tree) of Connection 147, Instance 148 and Reference Phrases 146 that repeat in that sequence as often as specified by the controlling Logic 2. Each Phrase Type may be followed by multiple Phrases of the next type.

For example, the Connection Phrase called “Dog” may be followed by the Instance Phrases called “Rover”, “Fido” and “Spot”. The Instance Phrase called “Rover” can be followed by the Reference Phrases called “Owned By”, “Fed By”, “Has Bitten”. The Reference Phrase called “Fed By” would usually be followed by the Connection Phrase called “Person” but could also be followed by the Connection Phrase called “Dog Feeding” if it had a Factual Role (3 Roled, Ordinal Role, and Repeated Roles also give multiple Connection Phrases).

The automatic selection of suitable Presentations for components of Data Displays depends on the population of Data returned by the interpretation and the applicable Styles which expresses the Users intentions.

Because there is no fixed format for a display, there is no need to limit the size of text used as the names of Members of any particular Types. All the Data is always retrieved before any is displayed so it can be analysed to determine optimum layout such as column widths.

Turning now to the programming considerations involved in networking the present invention. With fast communications (ie LAN) between server and clients it is possible to perform much of the work on the clients. The server handles the disk files, low level insertions and deletions into Ordered Stores and the distribution of information to the clients in the form of B Tree 39 blocks and Thing 8 Records. The clients cache this information and run the Logic Interpreter 256, Presentation System Logical external interface) 3 and User Actions 4.

In the preferred embodiment, with slow communications (such as the Web) only the final screen presentation, cursor movements, text editing and initial Operation invocation are done by the clients.

It is possible to have a hierarchy of servers with a single Insertion and Deletion server supporting many LAN distribution servers. LAN distribution server can then handle clients and Web distribution servers. FIG. 47 illustrates a Typical Server Hierarchy used for implementing the present invention in a networked environment.

Comparing the Invention with Existing Information Systems

It will be appreciated from the foregoing discussion that the present invention is an information system that involves a distinct shift in thinking from existing databases, word processors, spreadsheets and specific applications. The following discussion highlights some of the more significant differences.

The present invention is capable of providing the functionality of word processors, spreadsheets, databases in a single small program. In addition, most specialist business applications can be rapidly replaced by applications developed in this invention.

Compared to prior art systems, this invention has more common principles and far fewer special features. Once the common principles are learned, all applications may are accessible, although their specialist terms will need to be learned.

The present invention is quite distinct from known database systems. Rather than using tables, this invention uses Types 20 and Associations 21 to directly organise all information. These are easy to create and provide a common method of reference for all purposes.

When designing a new application using a prior art relational database, programmers usually begin the process by drawing an Entity Relationship Diagram such as that shown in FIG. 8. However, relational databases do not store information as Entities or Relationships but instead store information in Tables with rows and columns. As the database is further developed, the Entity Relationship model is lost and so are most users.

The next step in developing a database application is usually an analysis of functional dependencies followed by an elaborate set of data normalisation techniques which are intended to arrive at an optimum set of tables which will approximate the desired Entities and Relationships. The developer must then designate primary keys, compound keys, foreign keys and the like. In contrast, the present invention implements Types and Associations directly.

Many To Many Relationships are not easily handled by relational databases. An example would be “a person may use many cars and a car may be used by many persons”. Relaxing a One To Many relationship to a Many To Many will usually involve the creation of a new separate Table with lots of consequential work. In contrast, the present invention does not have any difficulty dealing with many to many relationships.

Relational databases do not provide convenient methods for implementing subtyping with integrity. In contrast, the present invention allows a Type (such as Male) to be a Subtype of another Type (such as Person). This implies that all males are persons but not all persons are males. Males will inherit all the Associations that involve persons but may introduce more Associations specific to males (such as beard length). Subtyping is important in allowing the Associations in a display to adapt to the kind of data being presented.

In prior art relational databases, once the Tables have been implemented using a Data Definition Language, data can be entered and modified using Data Manipulation Languages before being retrieved by Database Query Languages. Each of these have elaborate rules and conventions. Often programming in a language such a Visual Basic may be needed before an application will be considered viable. In contrast, as the Types and Associations of this invention are created, the application rapidly becomes useable. Data can be entered immediately after the first new Type has been created. As such new sorts of information can be readily incorporated into this information system.

The present invention is also quite distinct from known word processors. Most word processors allow characters to be typed anywhere on a blank page. They then attempt to infer the existence of paragraphs and other divisions. The scope of most operations is indicated by the user marking some text which might or might not correspond to a paragraph or some other formal division.

In contrast, the present invention uses Associations 21 to relate one paragraph to other paragraphs and other things. In this way, the presentation of the information is separate from content. One entry method is used for all words and text everywhere and styles 75 are used to display that information in various ways.

The present invention's unit of storage is also different. Most word processors operate on a file which represents a whole letter or document. It is therefore difficult to reuse portions of the document in other documents or to refer to paragraphs or phrases within the document. In contrast, words and paragraphs are stored individually in the present information system and are readily accessible from anywhere and can be found by searching by any of that paragraphs' characteristics.

Word processors usually occupy the full screen and are unsuitable for the frequent entry of small fragments of text such as the fields of a form or for data entry in general. They provide little assistance in finding existing files. The present invention has no such difficulties.

This invention provides only the paragraph, however a paragraph without spaces is known as a word, a word with only one character is a character. Any desired Associations between paragraphs, words and characters may be established by a user 14.

In the present invention, because only single paragraphs are ever entered or edited at one time, one common method is used for entering every word of text. This includes the paragraphs of a letter, names of parts in a purchase order, names of Types or Associations, or even words used in queries. In this way, common, powerful facilities are made universally available.

Furthermore, whilst most word processors provide some template capability, the present invention uses the normal Types, Subtypes and Associations to define that a Letter must be addressed to some known body, at their known address and must have as subject any thing 8. As such, all text must be entered in accordance with a template. FIG. 9 shows a message being created in a template.

As mentioned briefly above, this invention uses Styles 75 to vary the output from one that is appropriate for the interactive creation of a letter to one that is expected by the reader of a hardcopy. In this invention, because the style is not part of the letter, a letter may easily be printed in a Memo style for internal distribution. FIG. 10 shows an example of a message shown in Memorandum Style 150. As shown in FIG. 11, by applying a different style to the message, the information can be presented in a Letter Style. The message could also be presented in the style appropriate to an overhead projector, or any other style needed.

Furthermore, in the present invention, because a paragraph may be found from any words it contains, anything can be found from words in it's name. This facility is universally available in this invention and provides extremely powerful information searching capabilities.

In prior art word processors, spell checkers and thesaurri are often provided but the integration is not based upon any principles common to other tools or applications. In contrast, the spelling of words is integral to their identity and spelling corrections can be made in the same way as many other operations.

Relevancy Of Knowledge—Little word processor knowledge is of benefit with relational databases or spreadsheets. Sometimes a specialist application may invoke a word processor to operate on a large amount of text but smaller amounts are done with various ad hoc approaches, each offering different facilities.

The present invention is also quite distinct from known spreadsheet programs. This invention uses a tabular presentation whenever appropriate, and as a Association may yield a number calculated on the basis of a formula, this invention therefore requires no specific spreadsheet features.

Separation Of Formula And Data—Within this invention there is a total separation of formulae and data. It is possible to create, review and alter the formulae without reference to the data. Only the final pertinent data need be displayed. The base data can be entered and maintained with powerful ‘database’ facilities and displayed in any relevant fashion, completely independently from the final ‘spreadsheet’.

Reusability Of Formulae—If the concept of Profit (being Income minus Expenditure) occurs in a spreadsheet, it is likely to be expressed as B12-C12 which is not reusable in other spreadsheets let alone in a database.

In this invention each formula is a separate Association between the appropriate Types (e.g. Company and Dollars) and may be referred to wherever it is appropriate.

Ad Hoc Data Storage—Spreadsheets are often used as ad hoc databases because of the time and effort required to set up a relational database for a specific application. However, they provide even less integrity than a relational database and almost none of the facilities necessary to efficiently maintain the data. In contrast, highly productive applications can be created quickly enough using the present invention to discourage such use of spreadsheets.

Relevancy Of Knowledge—little of the knowledge gained while using spreadsheets is of much benefit with relational databases or word processors.

The present invention is also quite distinct from specific software application programs such as accounting packages. This invention's applications differ in their specific Types, Subtypes and Associations but are identical in most other respects. The backbone of the system and the operations used remain the same no matter what kinds of information are stored in the database. Appropriate operations are universally available and all displays are automatically formatted according to identical principles.

Organisation—In this invention an application is alnost totally organised by it's Types, Subtypes and Associations. These are visible on every display so that the meaning of every phrase presented can be clearly determined.

Extensibility—This invention's applications can be readily extended at any time by any permitted developer. This extension includes the ability to add new Types, Subtypes and Associations and so provide entirely new capability. The associated changes to display logic are usually done automatically. New capability can be tested within minutes of the design discussion completing.

Universality of Logic—This invention uses only one method (Logic) to refer to Types and Associations for all purposes such as defining the things which are members of a particular Type, defining the data to be presented in a particular view, defining constraints on legal populations of Associations, defining new Operations, defining new Associations by reference to other Associations, defining how to form the full name of Things and the like.

Interrelation Of Applications—This invention's applications organise documentation and facilitate the transfer of applications to other similar systems but the application boundaries in no way interfere in browsing, querying within the same database. The Types and Associations form an uninterrupted network. Unlike prior art systems, specific applications such as databases and word processors are not opened, dosed or explicitly entered.

Exchange Of Applications—All information comprising an application can be easily exported as data to a text file which can be readily imported into another similar system. In this way, if person A develops a particular application and populates its new types 20 and associations 21 with members 26, they can send it to person B and person B's system will automatically accept those new types 20, associations 21 and members 26 without any programming required. In this way, new applications may be quickly created and distributed to other uses of this invention without difficulty.

Immediacy Of Help—Everything in this invention may be documented in a uniform way. Most things that need documentation naturally exist because the meanings of particular types 20, associations 21, operations 99 and the like can be retrieved by browsing down to the underlying building blocks that make it up. In this way, the documentation is available in one operation wherever a thing 8 is encountered. Every phrase in every display is inherently documentable, and is effectively documented whenever a thing 8 is created.

Availability Of Operations—Once a user has mastered an operation it will then be available where ever is it appropriate. In addition, those operations not yet masteted by a user cannot be accidentally invoked.

Display Standardisation—In the preferred embodiment of the present invention only two kinds of display are used, namely data displays 125 and logic displays 152. In one sense, logic displays queries or commands and data displays show the results of those queries. Users 14 who have only achieve the user level 102 of “Browsers” only encounter Data displays. As discussed previously, each Data display 125 is controlled by some Logic.

Display Consistency—In the preferred embodiment a display contains only what is specified by the references in the controlling Logic. The Association between each display phrase is also inherent in the Logic. All text appearing in a display will be either the name of something or the text of some paragraph. Content and many stylistic aspects can also be controlled. Although the invention has been described with reference to specific examples, it will be appreciated by those skilled in the art that the invention may be embodied in many other forms.

1. A computer implemented information system which arranges information according to types, members and associations wherein types group members with common attributes and wherein associations define relationships between types.

2. An information system according to claim 1 wherein particular types have members which belong to that type and which store samples of information that have the attributes of that type.

3. An information system according to claim 1 or claim 2 wherein a type has one or more subtypes which have more narrowly defined attributes than the type.

4. An information system according to any one of the preceding claims wherein a types has a super-type which has less narrowly defined attributes than the type.

5. An information system according to claim 4 wherein the interrelation of the types, associations, members, sub-type and super-types defines a concept net.

6. An information system according to any one of the preceding claims wherein the system is adapted to be operated by users who are permitted to create, delete or modify members, types and associations.

7. An information system according to claim 6 wherein the degree to which specific users are permitted to create, delete or modify members, types and associations is governed by a range of security features.

8. An information system according to any one of the preceding claims wherein the information includes:
(a) data which represents particular samples of information stored by particular members; and
(b) logic which refers to types and associations in order to specify many aspects of the system's behaviour.

9. An information system according to claim 8 wherein the system presents data and logic to users via a user interface which includes a logic display and a data display.

10. An information system according to claim 9 wherein the logic display presents logic in a readily understood fashion and allows that logic to be modified by the user.

11. An information system according to claim 10 wherein logic in the logic display controls the presentation of data but does not allow that data to be modified by the user.

12. An information system according to claim 9 to 11 wherein logic in the data display controls the presentation of data in the data display and allows that data to be modified by the user.

13. An information system according to claim 12 wherein the data display presents the logic as well as the data but does not allow the logic to be modified by the user.

14. An information system according to claim 13 further including a logic interpreter which generates a stream of reference phrases and connection phrases from the logic, generates instance phrases from the data in the same stream and uses the stream to drive the user interface.

15. An information system according to claim 14 wherein the reference phrases correspond to associations, connection phrases correspond to types and instance phrases correspond to data about members.

16. An information system according to claim 15 wherein the logic and data displays present information in the order of: reference phrase, then connection phrase, then instance phrase.

17. An information system according to any one of the preceding claims wherein each type, member and association is allocated an internal identifier when it is created.

18. An information system according to claim 17 wherein the internal identifier is unique within the system.

19. An information system according to claim 18 wherein the internal identifier is:
(c) a 32 bit integer;
(d) a 64 bit integer; or
(e) a 128 bit integer.

20. An information system according to any one of the preceding claims wherein the majority of the information is physically stored in a pair of ordered stores.

21. An information system according to claim 20 wherein all of the information contained in one association is physically stored in two sorts of ordered stores.

22. An information system according to claim 20 or claim 21 wherein one sort of the ordered stores is a high volume ordered store which includes a plurality of B-tree records.

23. An information system according to any one of claims 20 to 22 wherein the other sort of ordered store is a high speed ordered store which is distributed amongst a plurality of variable length data records each of which represents a single type, member or association and contains portions of all high speed stores which relate to its subject type, member or association.

24. An information system according to any one of claims 20 to 23 wherein most of the functionality of the system is provided by an executable file interacting with only two files, which correspond to the two sorts of ordered stores.

25. An information system according to any one of the preceding claims including a user interface which, when requested, assembles information into a presentation format.

26. An information system according to claim 25 wherein the presentation format includes a tabular presentation, a plot presentation, a textual presentation and a diagrammatic presentation.

27. An information system according to any one of the preceding claims wherein the system provides the capabilities of a word processor, a database and a spreadsheet program, all in the one program.

28. An information system including:
(a) a Concept Net which is referenced by;
(b) a Universal Logic which provides data organised into Phrases for;
(c) a Logical External Interface which collects, formats and presents the data to Display Means.

29. An information system according to claim 29 wherein the Display Means can be acted upon by;
(d) a User Action System which provides an extensible set of user Operations which enable the user to enter and modify data in the Concept Net.

30. An information system according to claim 29 wherein the Concept Net is organised by one or more Types, Associations, Subtypes, Nested Types and/or Contained Types such that it can be directly referenced by the Universal Logic.

31. An information system according to claim 30 wherein the Concept Net is extendable and is without limit.

32. An information system according to any one of claims 28 to 31 wherein the Universal Logic includes one or more Alternatives, References and/or Connections.

33. An information system according to any one of claims 28 to 32 wherein the Universal Logic is sufficiently powerful to control all display, manipulation, calculation, access and decision making necessary for a wide variety of purposes.

34. An information system according to any one of claims 28 to 33 wherein the universal logic presents data as connection phrases, reference phrases and instance phrases.

35. An information system according to any one of claims 28 to 34 wherein the Logical External Interface collects, formats and presents data in accordance with Styles. More preferably, the Logical External Interface presents data to Display Means which include interactive windows, reports and external files.

36. An information system according to any one of claims 28 to 35 wherein many of the Phrases of the interactive windows can be acted upon by the User Action System.

37. An information system according to any one of claims 28 to 36 wherein all the Phrases of the interactive windows can be acted upon by the User Action System.

38. An information system according to any one of claims 28 to 37 wherein the User Action System provides an extensible set of user Operations which are available on many of the Phrases of the appropriate Type.

39. An information system according to claim 38 wherein the User Action System provides an extensible set of user Operations which are available on all of the Phrases of the appropriate Type.

40. An information system according to claim 39 wherein the user Operations are sufficient to productively enter and modify any data in the Concept Net and to extend the organisation of the Concept Net without limit.

41. A computer implemented information system including a Concept Net which is organised so that it can hold sufficient information to:
(a) define itself;
(b) define user applications; and
(c) control the operation of the entire information system.

42. An information system according to claim 41 wherein the Concept Net defines itself using Types, Subtypes, Contained Types, Nested Types, Associations and/or Roles.

43. An information system according to claim 41 or 42 wherein the Concept Net defines user applications using Logic, Definition Types, Styles and/or Operations.

44. An information system according to any one of claims 41 to 43 wherein the Concept Net controls the operation of the entire information system including user applications.

45. A method for organising a Concept Net so that it can hold all information necessary to:
(a) define itself—using Types, Subtypes, Contained Types, Nested Types, Associations and Roles;
(b) define user applications—using Logic, all the remaining system Definition Types, Styles, Operations; and
(c) control the operation of the entire information system including user applications.

46. A computer implemented method for implementing a user interface covering all information contained in a Concept Net, which relies only on information within the same Concept Net and in which no programming or arbitrary human decisions are required

47. A computer implemented method for intersecting on a Connection, based upon ordered storage.

48. An information system according to claim 47 further including Constraints.

49. An information system according to claim 48 wherein the Constraints specify a situation which must not be allowed to occur in the Concept Net.

50. An information system according to claim 49 wherein the system includes an efficient enforcement mechanism on insertion and deletion in Associations.

51. An information system according to claim 50 wherein the system includes a summary of all constraints that effect a particular Association.

52. A method for clearly specifying a situation which must not be allowed to occur in the Concept Net (ie a Constraint) which leads by Transformation to an efficient enforcement mechanism on insertion and deletion in Associations and naturally results in a clear summary of all constraints that effect a particular Association.

53. An information system as claimed in any of claims 28 to 52 wherein Associations include Logical Associations and Enumerated Associations.

54. An information system according to claim 53 wherein the system BOTH allows a Logical Association to maintain a parallel Enumerated Implementation to save continual reWO interpretation AND which allows changes in one Enumerated Association to have consequential effects in another Enumerated Association.

55. An information system according to claim 54 wherein the Universal Logic undergoes Transformation resulting in one efficient effect mechanism and a clear summary of all the consequential effects of a particular Association.

56. An information system which employs a method which BOTH allows a Logical Association to maintain a parallel Enumerated Implementation to save continual re-interpretation AND which allows changes in one Enumerated Association to have consequential effects in another Enumerated Association by allowing an Association to be both Enumerated and Logical.

57. An information system according to claim 56 wherein the Logic undergoes Transformation resulting in one efficient effect mechanism and a clear summary of all the consequential effects of a particular Association.

58. A method for constructing an information system including:
(a) a Concept Net which is organised by Types, Associations, Subtyping, Nested Types and Contained Types such that it can be directly referenced by:
(b) a Universal Logic consisting of Alternatives, References and Connections sufficiently powerful to control all display, manipulation, calculation, access and decision making necessary for all business purposes and wherein the Logic provides data organised into Connection Phrases, Reference Phrases and Instance Phrases for:
(c) a Logical External Interface which (in accordance with Styles) collects, formats and presents the data to interactive windows, reports and external files; and wherein every phrase of the interactive windows can be acted upon by:
(d) a User Action System providing an extensible set of user Operations which are available on every Phrase of the appropriate Type, which are sufficient to productively enter and modify any data in the Concept Net and to extend the organisation of the Concept Net without limit.

59. An information system according to claim 24 wherein the two files are merged into one file.

60. A computer implemented information system which arranges information according to instances wherein instances include numbers, ephemerals and things.

61. An information system according to claim 60 wherein things include formal references, text, roles, definitions, users, history and other user-created things.

62. An information system according to claim 61 wherein text includes words and links.

63. An information system according to claim 62 wherein words include characters.

64. An information system according to claim 61 wherein definitions include concepts, commands and logical definitions; and these definitions may be accessed via roles, each role involving a type; and these definitions may be referenced by the universal logic.

65. An information system according to claim 64 wherein concepts include types and associations and wherein these concepts are referenced in the logic of views and definition of other concepts.

66. An information system according to claim 65 wherein types include types of thing, contained types, simple subtypes, complex subtypes, quantities and numeric units.

67. An information system according to claim 64 wherein logical definitions include commands, views, constraints, defaults and naming views.

68. An information system according to any one of claims 60 to 67 wherein each thing is allocated an internal identifier when it is created.

69. An information system according to claim 68 wherein the internal identifier is unique within the system.

70. An information system according to claim 69 wherein the internal identifier is:
(f) a 32 bit integer;
a 64 bit integer; or
(h) a 128 bit integer.

71. An information system according to any one of claims 60 to 70 wherein the majority of the information is physically stored in a pair of ordered stores.

72. An information system according to claim 71 wherein all of the information contained in one association is physically stored in two sorts of ordered stores.

73. An information system according to claim 71 or claim 72 wherein one sort of the ordered stores is a high volume ordered store which includes a plurality of B-tree records.

74. An information system according to any one of claims 71 to 73 wherein the other sort of ordered store is a high speed ordered store which is distributed amongst a plurality of variable length data records each of which represents a single thing and contains portions of all high speed stores which relate to its subject thing.

75. An information system according to any one of claims 71 to 74 wherein most of the functionality of the system is provided by an executable file interacting with only two files, which correspond to the two sorts of ordered stores.

76. An information system whose logic can handle freely intermixed references to database concepts (using the implementation: enumerated), to numerical concepts (using the implementation: primitive) and to externals such as computer file system (using the implementation: primitive).

77. An information system according to claim 40 wherein the option exists for all display phrases to automatically be allocated a key stroke, the pressing of which will immediately move the cursor to the said display phrase.

78. A method of ensuring the integrity of an information system being used by multiple simultaneous users which allows updates to cause cascading consequential effects while complying with any number of constraints.

79. An information system substantially as described herein with reference to the accompanying drawings.

80. A method of generating an information system substantially as described herein with reference to the accompanying drawings.
